(19) United States
(12) Patent Application Publication
(10) Pub. No.: US 2025/0218128 A1
(43) Pub. Date: Jul. 3, 2025

(54) SYSTEMS AND METHODS FOR GENERATING PROPERTY LAYOUTS AND ASSOCIATED FUNCTIONALITY

(71) Applicant: Matterport, Inc., Sunnyvale, CA (US)

(72) Inventors: Kevin Balkoski, San Mateo, CA (US); David Alan Gausebeck, Sunnyvale, CA (US)

(73) Assignee: Matterport, Inc., Sunnyvale, CA (US)

(21) Appl. No.: 19/004,162

(22) Filed: Dec. 27, 2024

Related U.S. Application Data
(60) Provisional application No. 63/616,489, filed on Dec. 29, 2023.

(51) Int. Cl. G06T 19/00; G06T 3/16; G06V 10/762; G06V 10/764; G06V 10/82; G06V 20/64; G06V 20/70; G06V 30/422

(52) U.S. Cl. CPC G06T 19/003; G06T 3/16; G06V 10/762; G06V 10/764; G06V 10/82; G06V 20/647; G06V 20/70; G06V 30/422; G06T 2210/04; G06T 2210/56; G06T 2219/004

(57) ABSTRACT

An example method includes receiving 3D data of an interior of a building that has one or more stories and one or more rooms on the one or more stories. The 3D data is classified by receiving multiple 360 degree panoramic images of the interior, applying a trained model to classify the multiple 360 degree panoramic images, and determining, based on applying the trained model to classify the multiple 360 degree panoramic images, one or more room classifications for the 3D data. One or more story identifications of the one or more stories and one or more room identifications of the one or more rooms are generated. A property layout of the building that includes the one or more story identifications and the one or more room classifications is generated. The property layout is provided for display.

### CROSS-REFERENCE TO RELATED APPLICATION

This application claims priority to and seeks the benefit of U.S. Provisional Patent Application No. 63/616,489, filed on Dec. 29, 2023, and entitled “SYSTEMS AND METHODS CLASSIFYING SPACES USING MULTIPLE PANORAMA VIEWS AND DEEP NEURAL NETWORKS,” which is incorporated in its entirety herein by reference.

### FIELD OF THE INVENTION(S)

Embodiments of the present invention(s) generally relate to generating property layouts, and in particular to generating property layouts using 3D data, panoramic images, and neural networks.

### BACKGROUND

Creating a property layout, such as a floor plan of a house, is generally a labor-intensive process. Tools that may be used to create a floor plan of the house include a tape measure, a laser distance measurer, graph paper, and software. A person typically starts by measuring the exterior of the home to establish its footprint, followed by making detailed interior measurements of each room. The person will record dimensions, ceiling heights, and the placement of doors, windows, and built-ins like closets or cabinets. The person will then create a draft of the floor plan using graph paper or software, starting with the exterior outline and adding interior walls, doors, and other features. Once the draft is complete, the person typically will double-check all measurements by revisiting the home and comparing the floor plan to the physical environment. The person will adjust any discrepancies or add missing details during this verification phase.

The person will then refine the floor plan by labeling each room, adding dimensions, and including any additional features or annotations needed for the purpose of the floor plan. The person may digitize the floor plan if the floor plan was created on paper.

### SUMMARY

An example non-transitory computer-readable medium comprising executable instructions. The executable instructions being executable by one or more processors to perform a method, the method comprising: receiving 3D data of an interior of a building, the building having one or more stories and one or more rooms on the one or more stories, classifying the 3D data by: receiving multiple 360 degree panoramic images of the interior, the multiple 360 degree panoramic images associated with the 3D data, applying a trained model to classify the multiple 360 degree panoramic images, and determining, based on applying the trained model to classify the multiple 360 degree panoramic images, one or more room classifications for the 3D data, generating, based on the 3D data, one or more story identifications of the one or more stories and one or more room identifications of the one or more rooms, generating, based on the one or more story identifications and the one or more room identifications, a property layout of the building, the property layout including the one or more story identifications and the one or more room classifications, and providing the property layout for display.

In some embodiments, applying the trained model to classify the multiple 360 degree panoramic images includes: for each 360 degree panoramic image of the multiple 360 degree panoramic images: dividing each 360 degree panoramic image into multiple sections, and applying the trained model to classify each section of the multiple sections, thereby obtaining multiple section classifications, wherein determining, based on applying the trained model to classify the multiple 360 degree panoramic images, the one or more room classifications for the 3D data includes determining, based on the multiple section classifications for each 360 degree panoramic image, the one or more room classifications for the 3D data.

In one example, generating, based on the 3D data, the one or more story identifications includes: identifying walkable areas in the 3D data, clustering the walkable areas into one or more clusters for the one or more stories, identifying, based on the one or more clusters, one or more floor surfaces, identifying, for each floor surface of the one or more floor surfaces, one or more walls connected to each floor surface, and generating, based on the one or more floor surfaces and the one or more walls connected to each floor surface of the one or more floor surfaces, the one or more story identifications.

In various embodiments, identifying the walkable areas in the 3D data includes: generating, based on the 3D data, a 3D distance map, determining, for each point of multiple points in the 3D distance map, a distance from each point to a nearest surface of the 3D data, and identifying, based on the distance from each point to the nearest surface of the 3D data, the walkable areas in the 3D data.

In some embodiments, identifying the walkable areas in the 3D data further includes: generating an ellipsoid representing a human, scaling down by a factor in a z-direction the ellipsoid to a sphere, and scaling down by the factor in the z-direction the 3D data, wherein identifying, based on the distance from each point to the nearest surface of the 3D data, the walkable areas in the 3D data includes identifying, based on the distance from each point to the nearest surface of the 3D data and a diameter of the sphere, the walkable areas in the 3D data.

In one example, generating, based on the 3D data, the one or more room identifications includes: determining, based on the 3D data, one or more potential room centers, determining one or more paths between one or more pairs of two potential room centers of the one or more potential room centers, determining, based on the one or more paths and the 3D data, one or more doorways, blocking the one or more doorways to generate one or more blocked doorways, and generating, based on the one or more potential room centers and the one or more blocked doorways, the one or more room identifications.

In some embodiments, generating, based on the one or more story identifications and the one or more room identifications, the property layout of the building includes: generating, based on the one or more story identifications, one or more graphs, for each graph of the one or more graphs, simplifying each graph to generate a simplified graph, thereby generating one or more simplified graphs, and generating, based on the one or more simplified graphs and the one or more room identifications, the property layout of the building. In various embodiments, simplifying each graph to generate the simplified graph includes simplifying each graph using at least one of a global nonlinear optimizer and one or more rule-based simplifications.

In various embodiments, the method further comprising determining, for at least one room of the one or more rooms, at least one of a room area, a room volume, a first room dimension, and a second room dimension, wherein providing the property layout for display includes providing, for the at least one room of the one or more rooms, at least one of the room area, the room volume, the first room dimension, and the second room dimension for display.

In various embodiments, the method further comprising: receiving one or more modifications to the property layout, generating, based on the one or more modifications, a modified property layout, and providing the modified property layout for display.

An example method comprising: receiving 3D data of an interior of a building, the building having one or more stories and one or more rooms on the one or more stories, classifying the 3D data by: receiving multiple 360 degree panoramic images of the interior, the multiple 360 degree panoramic images associated with the 3D data, applying a trained model to classify the multiple 360 degree panoramic images, and determining, based on applying the trained model to classify the multiple 360 degree panoramic images, one or more room classifications for the 3D data, generating, based on the 3D data, one or more story identifications of the one or more stories and one or more room identifications of the one or more rooms, generating, based on the one or more story identifications and the one or more room identifications, a property layout of the building, the property layout including the one or more story identifications and the one or more room classifications, and providing the property layout for display.

In one example, applying the trained model to classify the multiple 360 degree panoramic images includes: for each 360 degree panoramic image of the multiple 360 degree panoramic images: dividing each 360 degree panoramic image into multiple sections, and applying the trained model to classify each section of the multiple sections, thereby obtaining multiple section classifications, wherein determining, based on applying the trained model to classify the multiple 360 degree panoramic images, the one or more room classifications for the 3D data includes determining, based on the multiple section classifications for each 360 degree panoramic image, the one or more room classifications for the 3D data.

In various embodiments, generating, based on the 3D data, the one or more story identifications includes: identifying walkable areas in the 3D data, clustering the walkable areas into one or more clusters for the one or more stories, identifying, based on the one or more clusters, one or more floor surfaces, identifying, for each floor surface of the one or more floor surfaces, one or more walls connected to each floor surface, and generating, based on the one or more floor surfaces and the one or more walls connected to each floor surface of the one or more floor surfaces, the one or more story identifications.

In some embodiments, wherein identifying the walkable areas in the 3D data includes: generating, based on the 3D data, a 3D distance map, determining, for each point of multiple points in the 3D distance map, a distance from each point to a nearest surface of the 3D data, and identifying, based on the distance from each point to the nearest surface of the 3D data, the walkable areas in the 3D data.

In one example, identifying the walkable areas in the 3D data further includes: generating an ellipsoid representing a human, scaling down by a factor in a z-direction the ellipsoid to a sphere, and scaling down by the factor in the z-direction the 3D data, wherein identifying, based on the distance from each point to the nearest surface of the 3D data, the walkable areas in the 3D data includes identifying, based on the distance from each point to the nearest surface of the 3D data and a diameter of the sphere, the walkable areas in the 3D data.

In various embodiments, generating, based on the 3D data, the one or more room identifications includes: determining, based on the 3D data, one or more potential room centers, determining one or more paths between one or more pairs of two potential room centers of the one or more potential room centers, determining, based on the one or more paths and the 3D data, one or more doorways, blocking the one or more doorways to generate one or more blocked doorways, and generating, based on the one or more potential room centers and the one or more blocked doorways, the one or more room identifications.

In some embodiments, generating, based on the one or more story identifications and the one or more room identifications, the property layout of the building includes: generating, based on the one or more story identifications, one or more graphs, for each graph of the one or more graphs, simplifying each graph to generate a simplified graph, thereby generating one or more simplified graphs, and generating, based on the one or more simplified graphs and the one or more room identifications, the property layout of the building. In one example, simplifying each graph to generate the simplified graph includes simplifying each graph using at least one of a global nonlinear optimizer and one or more rule-based simplifications.

One example method further comprises determining, for at least one room of the one or more rooms, at least one of a room area, a room volume, a first room dimension, and a second room dimension, wherein providing the property layout for display includes providing, for the at least one room of the one or more rooms, at least one of the room area, the room volume, the first room dimension, and the second room dimension for display.

In various embodiments, the example method further comprises: receiving one or more modifications to the property layout, generating, based on the one or more modifications, a modified property layout, and providing the modified property layout for display.

An example system comprising at least one processor and at least one memory including executable instructions that when executed by the at least one processor cause the system to: receive 3D data of an interior of a building, the building having one or more stories and one or more rooms on the one or more stories, classify the 3D data by: receiving multiple 360 degree panoramic images of the interior, the multiple 360 degree panoramic images associated with the 3D data, applying a trained model to classify the multiple 360 degree panoramic images, and determining, based on applying the trained model to classify the multiple 360 degree panoramic images, one or more room classifications for the 3D data, generate, based on the 3D data, one or more story identifications of the one or more stories and one or more room identifications of the one or more rooms, generate, based on the one or more story identifications and the one or more room identifications, a property layout of the building, the property layout including the one or more story identifications and the one or more room classifications, and provide the property layout for display.

### BRIEF DESCRIPTION OF THE DRAWINGS

FIG. 1 depicts an example environment in which a property layout system may operate according to some embodiments.

FIG. 2 depicts a block diagram of the property layout system in some embodiments.

FIG. 3 is a flow diagram depicting a method for generating property layouts according to some embodiments.

FIG. 4 is a flow diagram depicting a method for classifying 3D data in some embodiments.

FIG. 5 is a flow diagram depicting a method for generating story identifications according to some embodiments.

FIG. 6 is a flow diagram depicting a method for generating room identifications according to some embodiments.

FIG. 7A depicts an example panoramic image of a building interior in some embodiments.

FIG. 7B depicts the example panoramic image of FIG. 7A divided into multiple vertical sections according to some embodiments.

FIG. 8A depicts another example panoramic image of a building interior in some embodiments.

FIG. 8B is a graph that depicts confidences for predicted room classifications for the example panoramic image of FIG. 8A according to some embodiments.

FIGS. 9A and 9B depict other example panoramic images of a building interior in some embodiments.

FIG. 10A depicts an example of a 3D mesh after aggregating classifications from multiple panoramic images according to some embodiments.

FIG. 10B depicts a property layout with room classifications in some embodiments.

FIGS. 11A and 11B are depictions of an ellipsoid and a sphere, respectively, inside a building in some embodiments.

FIG. 12 is a depiction of a building interior with pegs indicating walkable areas in the building according to some embodiments.

FIG. 13 is a depiction of a building separated into two stories in some embodiments.

FIGS. 14A and 14B depicts sample paths between two potential room centers according to some embodiments.

FIG. 15 depicts a distance to the nearest surface between the two potential room centers of the path depicted in FIG. 14B in some embodiments.

FIG. 16 is a depiction of doorways in a building blocked with finite planes according to some embodiments.

FIG. 17 is a depiction of a building with room classifications in some embodiments.

FIG. 18A depicts pixel intensity proportional to mesh area intersecting a column passing through the pixel according to some embodiments.

FIG. 18B depicts mesh face classification confidences in some embodiments.

FIG. 19 depicts a result of a room identification process according to some embodiments.

FIG. 20 depicts approximately vertical wall surfaces of a 3D mesh according to some embodiments.

FIG. 21 depicts an example property layout based on connected vertical wall surfaces of a 3D mesh in some embodiments.

FIG. 22 depicts another example property layout in some embodiments.

FIG. 23 depicts another example property layout in some embodiments.

FIG. 24 depicts an example property layout that may be provided in a user interface according to some embodiments.

FIG. 25 depicts a block diagram of an example digital device in some embodiments.

Throughout the drawings, like reference numerals will be understood to refer to like parts, components, and structures.

### DETAILED DESCRIPTION

One problem with existing processes for creating floor plans is that they are labor-intensive, especially if manual methods are used or frequent re-measurements are needed to address overlooked details or discrepancies. Furthermore, measurement errors can occur due to irregular room shapes, hidden features, or human oversight, leading to inaccurate floor plans. A lack of standardization in tools and techniques-such as using different scales or inconsistent annotations-can also cause confusion and miscommunication.

Various embodiments of a property layout system and associated methods and non-transitory computer-readable media as described herein may provide technical solutions to these and other technical problems. The property layout system may receive or generate 3D data, such as one or more 3D meshes, about an environment, such as a building. The property layout system may classify regions of the environment, such as types of rooms (for example, kitchen, living room, or bedroom) using a trained model, such as a neural network. The property layout system may use the 3D data to separate the environment into regions. For example, the property layout system may separate the environment into one or more buildings or a building into one or more stories and one or more rooms. The property layout system may then generate a property layout or other representation of the environment using the 3D data and the regions, such as the buildings, the one or more stories, and the one or more rooms. The property layout system may provide the property layout or other representation for display to users. Optionally, the property layout system may allow users to modify the property layout or other representation or to provide feedback on the property layout or other representation.

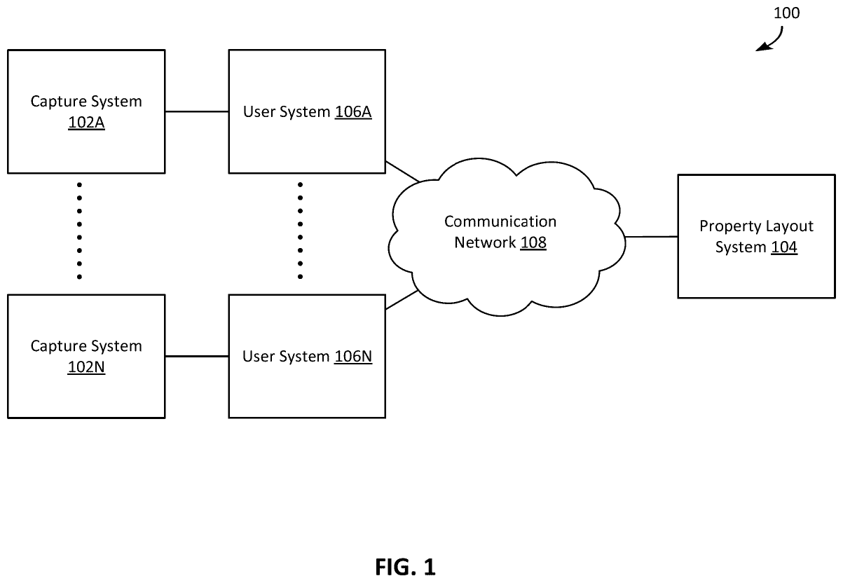

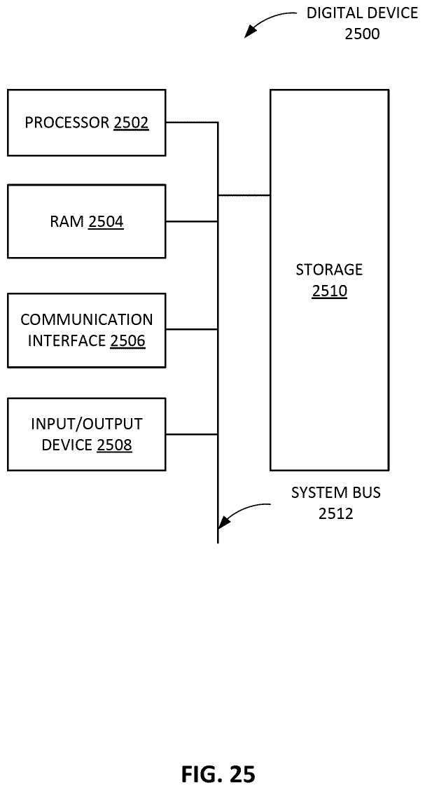

FIG. 1 depicts an example environment 100 in which a property layout system may operate according to some embodiments. The environment 100 includes multiple capture systems 102A through 102N (which may be referred to as a capture system 102 or as capture systems 102), multiple user systems 106A through 106N (which may be referred to as a user system 106 or as user systems 106), a property layout system 104, and a communication network 108. Each of the capture systems 102, the property layout system 104, and the user systems 106 may be or include any number of digital devices. A digital device is any device with at least one processor and memory. Digital devices are discussed further herein, for example, with reference to FIG. 25.

The capture systems 102 may each be or include a system that is configured to capture images or video or three-dimensional (3D) data of physical environments, such as buildings (for example, houses or office buildings), other structures, or outdoor environments, or provide the images or video or the 3D data of the buildings, other structures, or outdoor environments.

The images or video may be or include two-dimensional (2D) panoramic images that depict a field of view greater than that of the human eye. In some embodiments, the 2D panoramic images have a field of view of 360 degrees. The 3D data may be or include 3D depth data, such as depth images. The 3D data may be or include textured or untextured meshes, other 3D formats from Computer-Aided Design (CAD) software, Building Information Modeling (BIM) data, point clouds, depth maps, and implicit or latent representations in a NeRF or other neural network. In some embodiments, the 3D data includes aligned 3D panoramic views (RGB color values and depth per pixel). In various embodiments, the 3D data is generated from images or video.

The capture systems 102 may provide the 3D data or the images or video to the user systems 106. For example, the capture systems 102 may have scanning functionality to capture 3D data (for example, using a laser imaging, detection, and ranging device (LiDAR)) and imaging functionality to capture images or video (for example, using imaging sensors), and provide the captured 3D data or the images or video to a user system 106 via a Wi-Fi connection, a Bluetooth Low Energy (BLE) connection, or a wired connection to the user system 106. In various embodiments, the capture systems 102 provide the 3D data or the images or video to the property layout system 104.

The user systems 106 may each be or include one or more mobile devices (for example, mobile phones, tablet computers, or the like), desktop computers, laptop computers, or the like. The user systems 106 may receive 3D data or images or video from the capture systems 102. The user systems 106 may execute applications that process the 3D data or the images or video or display the 3D data or the images or video to users. The user systems 106 may provide the 3D data or the images or video, processed or not, to the property layout system 104. The user systems 106 may also receive property layouts from the property layout system 104, display property layouts to users, or receive requested modifications to property layouts from the users and provide the requested modifications to the property layout system 104. The user systems 106 may also perform other functions, such as providing property layouts to other systems (for example, computing systems of real-estate listing websites or other property information websites) and viewing property layouts as provided by such other systems (for example, the real-estate listing websites or other property information websites).

The property layout system 104 may be or include a system that receives 3D data or images or video from the user systems 106 or the capture systems 102. For example, the property layout system 104 may be or include one or more servers operated on-premises of an entity operating the property layout system 104 or off-premises at a facility operated by another entity. Although the environment 100 depicts a single one of the property layout system 104, it is to be understood that there may be multiple of the property layout system 104 in various configurations, such as a mixture of on-premises and off-premises at one or more facilities.

As described in more detail herein, the property layout system 104 may utilize the 3D data or images or video to generate property layouts. The property layout system 104 may provide the property layouts to the user systems 106 for display. The property layout system 104 may also receive requested modifications to property layouts from the user systems 106, modify the property layouts, and provide the modified property layouts to the user systems 106 for display. In some embodiments, the property layout system 104 provides property layouts to other systems (for example, computing systems of real-estate listing websites or other property information websites) for display.

In some embodiments, the communication network 108 may represent one or more computer networks (for example, local area networks (LANs), wide area networks (WANs), and/or the like). The communication network 108 may provide or facilitate communication between any of the capture systems 102, the property layout system 104, and any of the user systems 106. In some implementations, the communication network 108 comprises computer devices, routers, cables, or other network topologies. In some embodiments, the communication network 108 may be wired or wireless. In various embodiments, the communication network 108 may comprise the Internet, one or more networks that may be public, private, IP-based, non-IP based, and so forth.

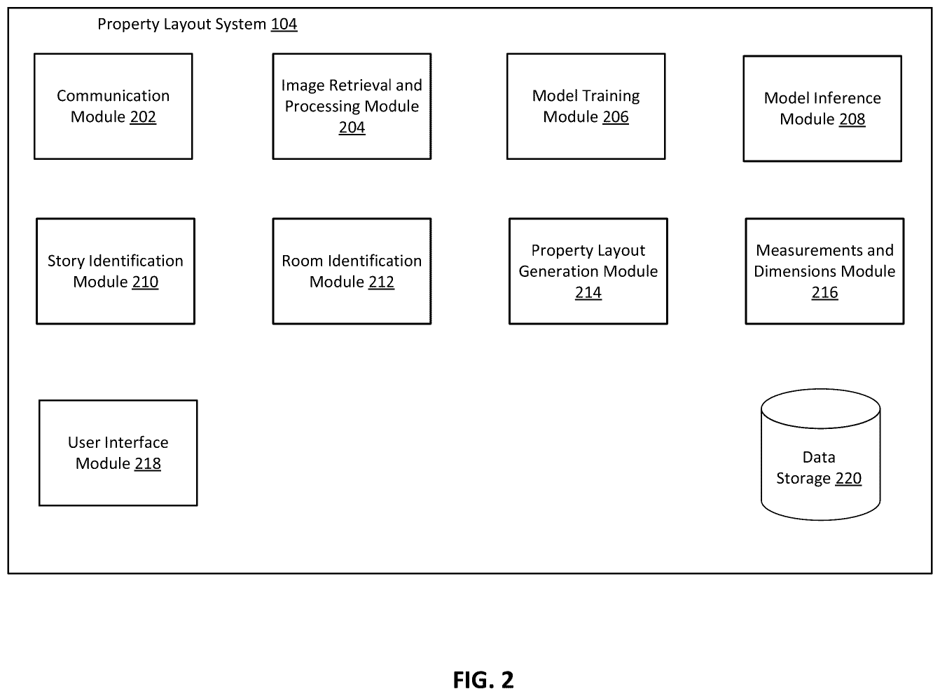

FIG. 2 depicts a block diagram of the property layout system 104 in some embodiments. The property layout system 104 may include a communication module 202, an image retrieval and processing module 204, a model training module 206, a model inference module 208, a story identification module 210, and a room identification module 212. The property layout system 104 may also include a property layout generation module 214, a measurements and dimensions module 216, a user interface module 218, and a data storage 220.

The communication module 202 may send requests or data between the property layout system 104 and any of the capture systems 102 and the user systems 106. The communication module 202 may also receive requests or data from any of the capture systems 102 and the user systems 106.

The image retrieval and processing module 204 may receive images, such as 360 degree panoramic images, and process the images. For example, the image retrieval and processing module 204 may process a 360 degree panoramic image with equirectangular projection image by dividing the image into multiple sections, each of which is classified. In some embodiments, the image retrieval and processing module 204 divides an image into 32 sections, each of which is classified.

The model training module 206 may train one or more artificial intelligence (AI) and/or machine learning (ML) models. In some embodiments, the model training module 206 may train a neural network, such as a neural network utilizing a Vision Transformer (ViT) architecture.

The model inference module 208 may perform inference on images of an environment using the one or more AI and/or ML models trained by the model training module 206. For example, the model inference module 208 may utilize the trained neural network utilizing a ViT architecture to classify sections of an image. The model inference module 208 may utilize the classified sections to generate classifications of 3D data or to generate room classifications.

The story identification module 210 may identify one or more stories of a building based on 3D data or 2D data for the building. The room identification module 212 may identify one or more rooms of one or more stories of a building based on 3D data or 2D data for an interior of the building. The property layout generation module 214 may generate a property layout of the building that includes the one or more story identifications of the building, the one or more room identifications of the building, and the room classifications.

The measurements and dimensions module 216 may generate measurements or dimensions of buildings, such as measurements or dimensions of rooms or other environments within the building interior. The user interface module 218 may generate user interfaces that include property layouts or instructions usable to generate property layouts for display to users.

The data storage 220 may include data stored, accessed, and/or modified by any of the modules of property layout system 104. The data storage 220 may include any number of data storage structures such as tables, databases, lists, and/or the like. The data storage 220 may include data that is stored in memory (for example, random access memory (RAM)), on disk, or some combination of in-memory and on-disk.

A module of the property layout system 104 may be hardware, software, firmware, or any combination. For example, each module may include functions performed by dedicated hardware (for example, an Application-Specific Integrated Circuit (ASIC), a Field Programmable Gate Array (FPGA), or the like), software, instructions maintained in ROM, and/or any combination. Software may be executed by one or more processors. Although a limited number of modules are depicted in FIG. 2, there may be any number of modules. Further, individual modules may perform any number of functions, including functions of multiple modules as described herein.

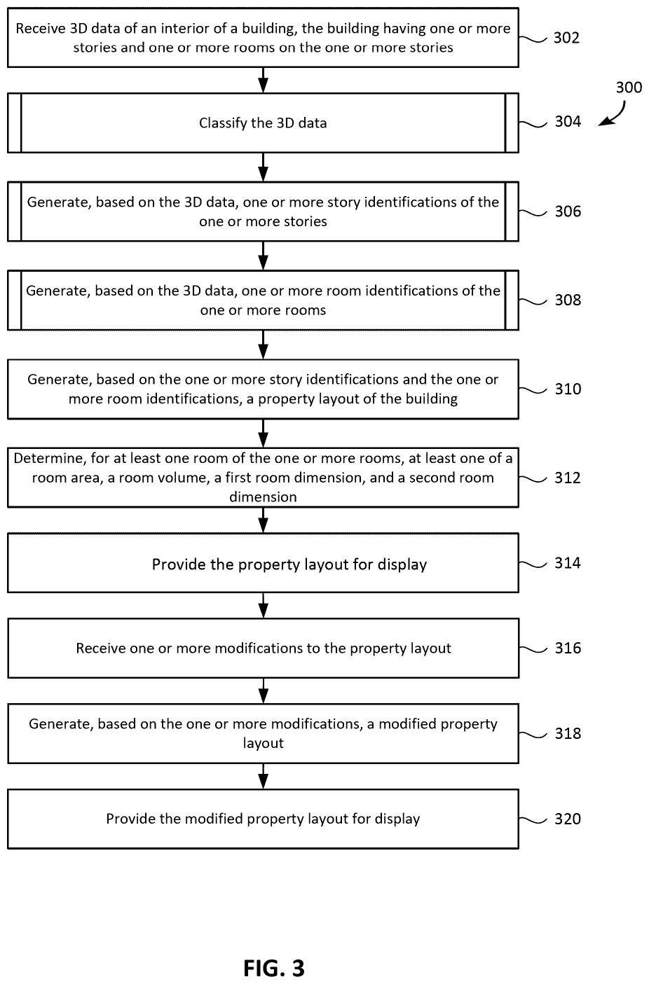

FIG. 3 is a flow diagram depicting a method 300 for generating property layouts according to some embodiments. The property layout system 104 (for example, various modules of the property layout system 104) may perform the method 300. The method 300 is described using the example of building interiors, but it will be understood that the method 300 is applicable to any environment, including outdoor spaces.

The method 300 begins at a step 302 in which the property layout system 104 (for example, the communication module 202) receives 3D data of an interior of a building that has one or more stories and one or more rooms on the one or more stories. For example, the property layout system 104 may receive textured 3D mesh data for the interior of the building. In some embodiments, the 3D data may be generated from images or video using photogrammetry, monocular depth estimation, neural radiance fields (NeRF), or other 2D-to-3D techniques. The images or video, in this case, may be received or captured with or without auxiliary position and orientation data. For some cases, such as generating a property layout of a single story of a building, the property layout system 104 may utilize 2D data in the same plane as the property layout, such as from a LiDAR ring scanner which only aims horizontally, instead of or in addition to 3D data.

At step 304 the property layout system 104 (for example, the model inference module 208) classifies the 3D data. The property layout system 104 utilizes a trained model to classify the 3D data. In some embodiments, the trained model is or includes a neural network that has a Vision Transformer (ViT) architecture. The property layout system 104 may utilize a neural network that has a ViT architecture, as such neural networks do not require explicit wrap-around padding to be implemented, in order to account for the fact that pixels on either side of a 360 degree panoramic image with equirectangular projection are related. The neural network may receive images as input and output a feature map. It will be understood that the property layout system 104 may utilize neural networks having other architectures, or other AI and/or ML models.

The model training module 206 may have pre-trained the backbone of the neural network on multiple images of environments, such as millions of 360 degree panoramic images of environments, in order to bias the neural network towards a domain of input images without requiring annotated data. After pre-training the backbone, the model training module 206 may attach a convolutional decoder which includes standard convolutional layers, normalization layers and nonlinearities. A fully connected multi-label classifier head of the neural network may receive a feature map from the convolutional decoder, flatten the feature map, and map the feature map to an output vector of dimensionality [1, no._of_sections*no._of_classifications] which results in a single probability score per section, per classification.

Once the model training module 206 has pre-trained the ViT backbone and added the convolutional decoder and the classifier head to the pre-trained ViT backbone, the model training module 206 may have trained the entire end-to-end classifier on an annotated dataset. The model training module 206 may have utilized two stages to train the entire end-to-end classifier. First, the model training module 206 may have frozen the weights of the ViT backbone and have only trained the convolutional decoder and the classifier head. Second, once performance has been saturated, the model training module 206 may have unfrozen the backbone weights and have fine-tuned with a lower learning rate, until the model training module 206 has determined that performance on a validation set has been maximized or increased.

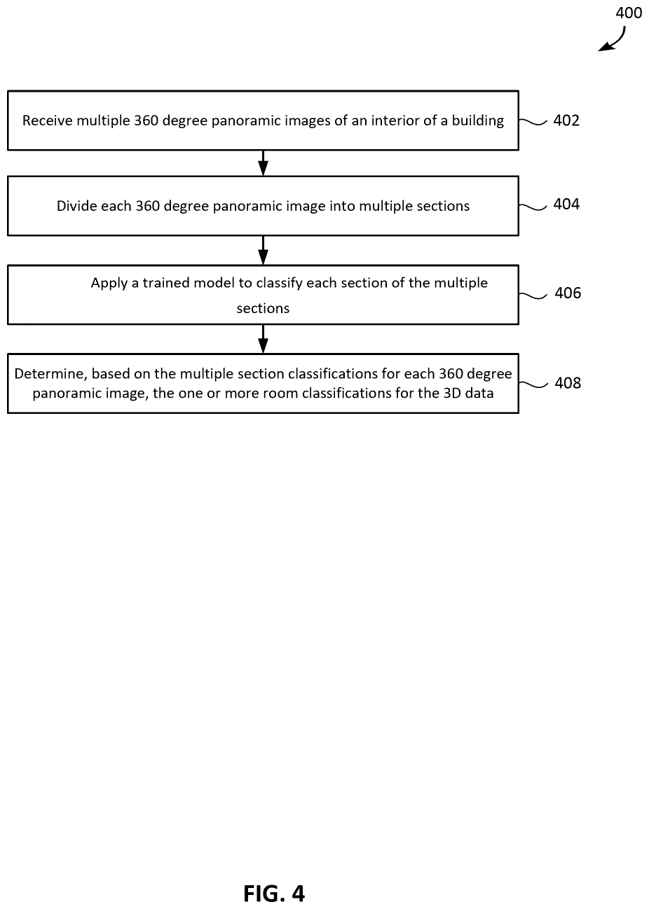

FIG. 4 is a flow diagram depicting a method 400 for classifying the 3D data in some embodiments. The property layout system 104 (for example, various modules of the property layout system 104) may perform the method 400. The method 400 is described using the example of building interiors, but it will be understood that the method 400 is applicable to any environment. Furthermore, the method 400 is described as the property layout system 104 classifying the 3D data to result in one or more room classifications for the 3D data. However, additionally or alternatively, the property layout system 104 may classify the 3D data as types of objects or materials, or as having other characteristics like indoor or outdoor, residential or commercial, or other characteristics.

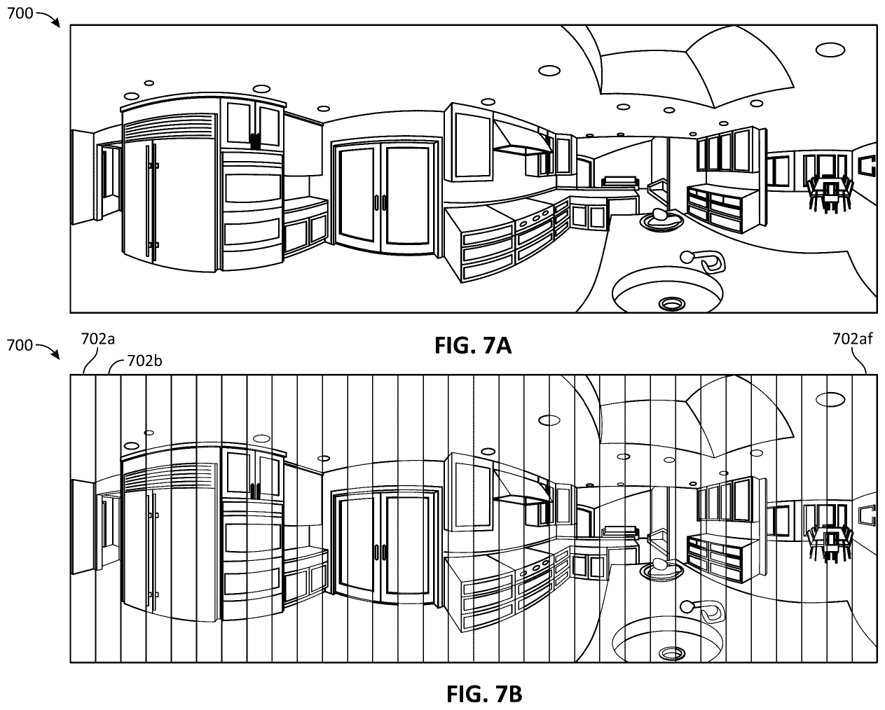

The method 400 begins at a step 402 in which the property layout system 104 (for example, the image retrieval and processing module 204) receives multiple 360 degree panoramic images of the interior that are associated with the 3D data. In various embodiments, the property layout system 104 receives multiple 360 degree panoramic images with equirectangular projection. FIG. 7A depicts an example panoramic image 700 of a building interior in some embodiments.

At step 404 the property layout system 104 (for example, the image retrieval and processing module 204) divides each 360 degree panoramic image into multiple sections. In some embodiments, the property layout system 104 divides each 360 degree panoramic image into 32 equally shaped vertical sections, each of which extends from an upper edge of the 360 degree panoramic image to a lower edge of the 360 degree panoramic image. FIG. 7B depicts the panoramic image 700 of FIG. 7A divided into 32 equally shaped vertical sections according to some embodiments. The 32 equally shaped vertical sections of the panoramic image 700 include a first vertical section 702a, a second vertical section 702b, and other vertical sections up to and including a 32nd vertical section 702af. It will be understood that the property layout system 104 may divide the 360 degree panoramic images into more or fewer sections, or that the property layout system 104 may utilize sections that have other shapes (for example, horizontal sections that span from a left edge to a right edge of a 360 degree panoramic image) or combinations of shapes.

Returning to FIG. 4, at step 406 the property layout system 104 (for example, the model inference module 208) applies a trained model to classify the multiple 360 degree panoramic images. In embodiments where the property layout system 104 divides each 360 degree panoramic image into multiple sections, the property layout system 104 may classify the multiple 360 degree panoramic images by, for each 360 degree panoramic image, applying the trained model to classify each section of the multiple sections. The property layout system 104 may thereby obtain multiple section classifications for each 360 degree panoramic image.

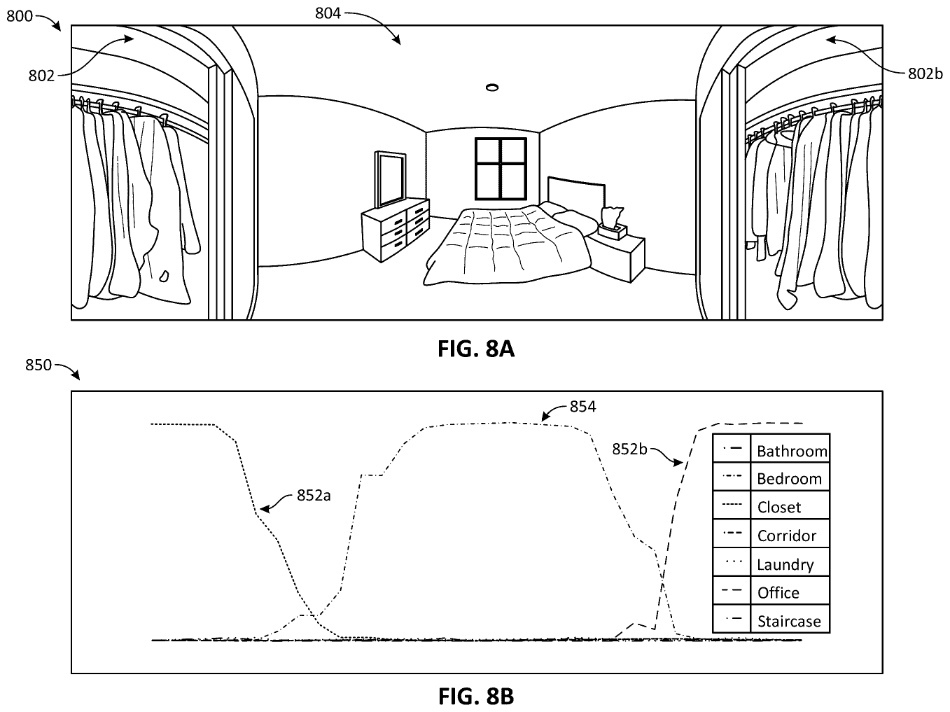

The property layout system 104 may apply a neural network that has a ViT architecture as described herein. FIG. 8A depicts an example 360 degree panoramic image 800 of another building interior in some embodiments. The 360 degree panoramic image 800 includes a first closet portion 802a, a bedroom portion 804, and a second closet portion 802b. Although not depicted in FIG. 8A, the property layout system 104 may have divided the 360 degree panoramic image 800 into 32 equally shaped vertical sections.

FIG. 8B is a graph 850 that depicts confidences for predicted room classifications for the 360 degree panoramic image 800 of FIG. 8A according to some embodiments. Each position along the abscissa of the graph 850 describes the confidence levels for the different classifications detected in the corresponding section in the 360 degree panoramic image 800. In this example, the property layout system 104 predicted that a closet classification has the highest confidences for the first closet portion 802a, as indicated by a section 852 of a line for the closet classification. The property layout system 104 has also predicted that a bedroom classification has the highest confidences for the bedroom portion 804, as indicated by a section 854a of a line for the bedroom classification. The property layout system 104 has also predicted that the closet classification has the highest confidences for the second closet portion 802b, as indicated by a section 854b of the line for the closet classification.

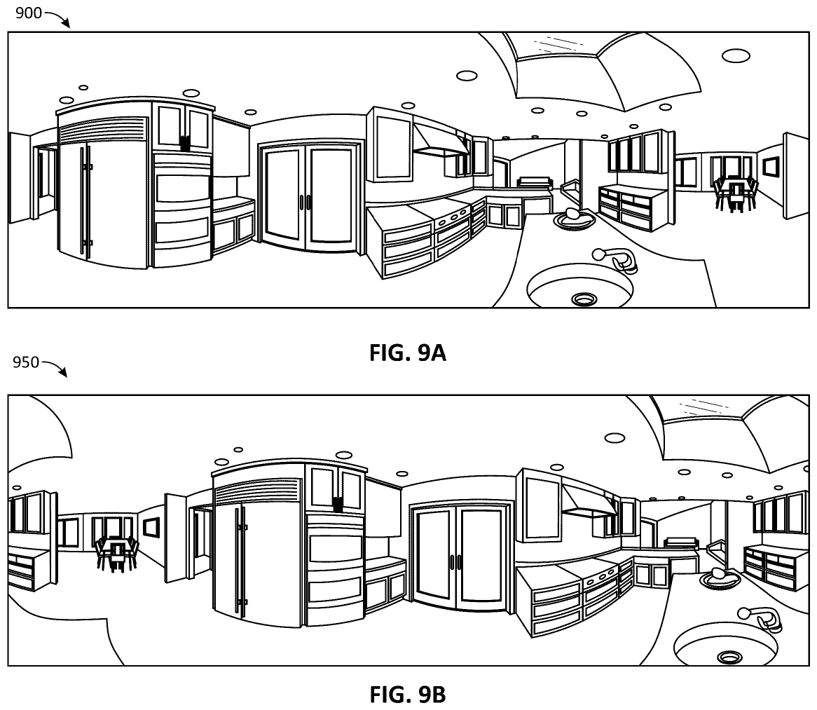

At step 408 the property layout system 104 determines, based on applying the trained model to classify the multiple 360 degree panoramic images, one or more room classifications for the 3D data. For example, the property layout system 104 may have classified multiple 360 degree panoramic images throughout the building interior and the 3D data may be or include one or more 3D meshes. The property layout system 104 may utilize the location or pose of each 360 degree panoramic image to project the predicted room classifications onto the one or more 3D meshes. In many cases a face in the one or more 3D meshes (for example, a triangle) is seen from multiple 360 degree panoramic images. By aggregating the predicted room classification from multiple 360 degree panoramic images, the property layout system 104 may obtain an aggregated prediction in the one or more 3D meshes with higher accuracy than from individual 360 degree panoramic images. Once faces in the one or more 3D meshes have been classified from multiple 360 degree panoramic images, the property layout system 104 may project from the faces in the one or more 3D meshes back to the multiple 360 degree panoramic images and get a prediction for an individual 360 degree panoramic image that has higher accuracy than the original prediction for the individual 360 degree panoramic image. FIGS. 9A and 9B depict other example 360 degree panoramic images 900 and 950, respectively, of a building interior in some embodiments.

In various embodiments, when aggregating predictions from multiple 360 degree panoramic images, the property layout system 104 may weight predictions from each individual 360 degree panoramic image by various factors. For example, the property layout system 104 may weight predictions by a distance from a device that captured the individual 360 degree panoramic image to a face in the one or more 3D meshes, an angle between a normal to the face in the one or more 3D meshes and a line segment from a centroid of the face to the device, or a confidence reported by the neural network in the classification. It will be understood that the property layout system 104 may utilize other factors to weight predictions from individual 360 degree panoramic images.

A single room may have multiple room classifications. For each room, the property layout system 104 may compute for each classification the average confidence over a subset of the faces in the one or more 3D meshes that maximized or increased the confidence subject to the area of the faces being above a threshold. The area threshold may be set to the expected size of a room. The property layout system 104 may utilize this technique to identify multiple classifications within the same area, for example, kitchen, living room and dining room, rather than using the average confidence over the entire room. The property layout system 104 may choose the classification with the highest average confidence as the final classification for the room. If the second highest average confidence is above a threshold, which may be adjustable, the property layout system 104 may add the corresponding classification as an additional room classification. The property layout system 104 may do so only if the resulting classifications are a valid room combination. For example, the property layout system 104 may consider “kitchen” and “living room” to be a valid combination, while “kitchen” and “bedroom” may be considered an invalid room combination. The property layout system 104 may similarly add additional room classifications.

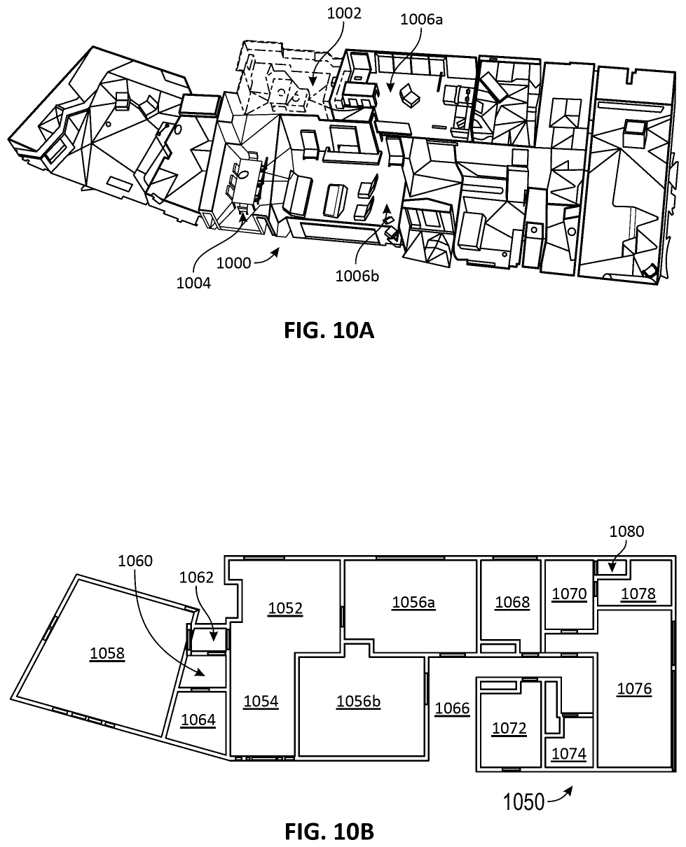

FIG. 10A depicts an example of a 3D mesh 1000 after the property layout system 104 has aggregated predictions from multiple 360 degree panoramic images according to some embodiments. The 3D mesh 1000 includes a section 1002 that the property layout system 104 has classified as a kitchen, a section 1004 that the property layout system 104 has classified as a dining room, a first section 1006a that the property layout system 104 has classified as a living room, and a second section 1006b that the property layout system 104 has also classified as a living room.

FIG. 10B depicts a property layout 1050 with predicted room classifications in some embodiments. The property layout system 104 may have generated the property layout 1050 based on the 3D mesh 1000 of FIG. 10A and predicted room classifications. The property layout 1050 includes a kitchen 1052 (corresponding to the section 1002 of the 3D mesh 1000), a dining room 1054 (corresponding to the section 1004 of the 3D mesh 1000), a first living room 1056a (corresponding to the first section 1006a of the 3D mesh 1000), and a second living room 1056b (corresponding to the second section 1006b of the 3D mesh 1000). The property layout 1050 also includes another living room 1058, a first bathroom 1060, a first hallway 1062, a laundry room 1064, a second hallway 1066, a first bedroom 1068, a second bedroom 1070, a third bedroom 1072, a second bathroom 1074, a fourth bedroom 1076, a third bathroom 1078, and a closet 1080.

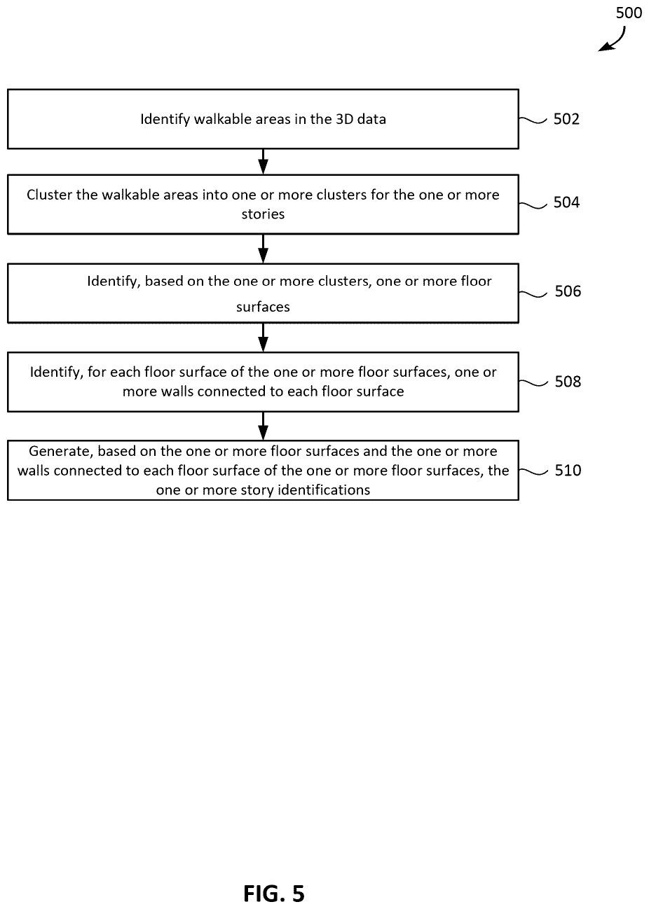

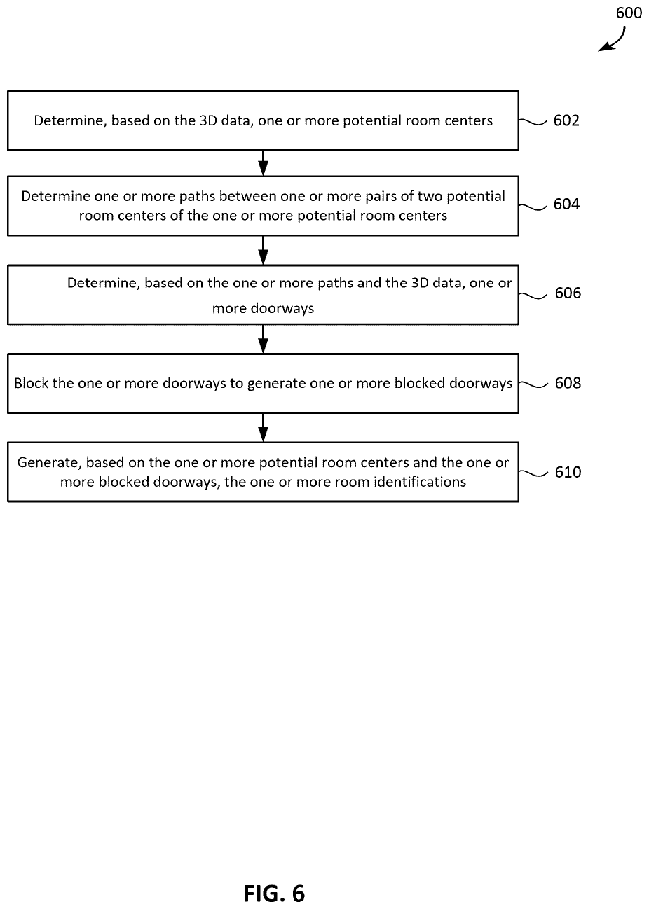

In various embodiments, the property layout system 104 utilizes data from other methods described herein, such as a method for generating story identifications, described with reference to, for example, FIG. 5, or a method for generating room identifications, described with reference to, for example, FIG. 6, to classify the 3D data. For example, if the property layout system 104 generates room identifications before classifying the 3D data or if the two methods are interleaved in an iterative manner, the property layout system 104 may aggregate the classifications per room and select a single classification of room type per room that was identified during the generation of room identifications. In some embodiments, the property layout system 104 may classify the 360 degree panoramic images without associating the resulting classifications with the 3D data.

Additionally or alternatively, the property layout system 104 may use other methods to classify the 3D data, such as running other neural networks against 2D images from the environment and optionally aggregating those classifications in the 3D data. Other neural networks that could produce other useful classifications of regions or objects include semantic and/or instance segmentation networks and object detection networks. In addition to running classification on 2D images and then aggregating the results in 3D, another approach the property layout system 104 may utilize is to segment the environment into regions (stories, rooms, objects etc.) first and classify those regions afterwards. Such classification could still use 2D images known to include the regions, or the classification could use 3D information about those regions such as dimensions, position, and shape or structure. For example, the property layout system 104 may separate an environment (for example, a building interior) into regions and then run a point cloud of each region through a neural network such as PointNet for classification. The property layout system 104 may also start with 3D data without segmenting the environment first, such as by passing a point cloud or graph derived from a 3D mesh representing the entire environment (for example, a building interior) to a network that does classification and/or region separation. It is also possible for this step to be assisted by manual annotations, notes, or other data about the environment that may be available. For example, a user capturing the environment might have added room names with spatial locations that the property layout system 104 may use to guide room type classifications.

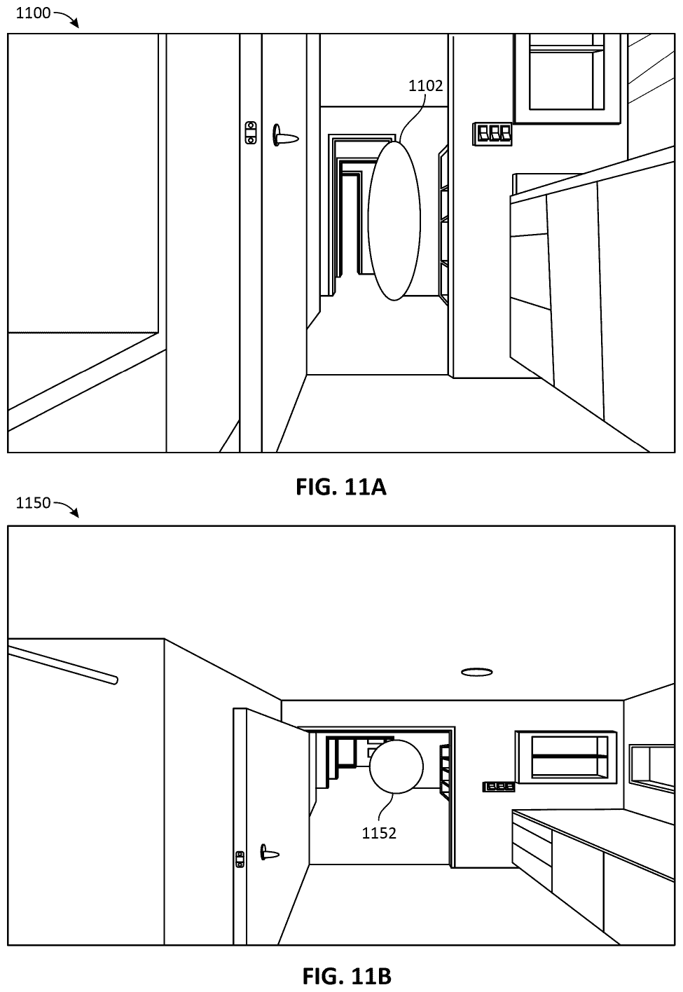

Returning to FIG. 3, at step 306 the property layout system 104 (for example, the story identification module 210) generates based on the 3D data, one or more story identifications of the one or more stories. For example, the property layout system 104 may use the 3D data and optionally the one or more room classifications to generate the one or more story identifications. FIG. 5 is a flow diagram depicting a method 500 for generating story identifications according to some embodiments. The property layout system 104 (for example, various modules of the property layout system 104) may perform the method 500. The method 500 begins at a step 502 in which the property layout system 104 (for example, the story identification module 210) identifies walkable areas in the 3D data. In some embodiments, the property layout system 104 identifies walkable areas by identifying where a human can fit in the 3D data. To do so, the property layout system 104 may begin by generating an ellipsoid representing a human that is aligned to the z-axis. The ellipsoid may have an axis in the z-direction of 1.8 meters (m) and axes in the x-direction and y-direction of 0.6 m. FIG. 11A depicts an image 1100 containing an ellipsoid 1102 inside a building in some embodiments.

The property layout system 104 may scale down the ellipsoid and the 3D data by a factor of 0.3 in a z-direction to convert the ellipsoid into a sphere with a diameter of 0.6 m and to reduce the dimensions of the 3D data by the factor of 0.3. The property layout system 104 may convert the ellipsoid into a sphere because a sphere is a simpler geometric construct than an ellipsoid, and thus may be more suitable for use by the property layout system 104. In some embodiments, the property layout system 104 does not scale down the ellipsoid. In some embodiments, the property layout system 104 scales down the ellipsoid but not the 3D data, or scales the ellipsoid and the 3D data down by different factors. FIG. 11B depicts an image 1150 containing a sphere 1152 generated by scaling down the ellipsoid 1102 in some embodiments.

The property layout system 104 may then create a 3D distance map with 0.20 m spacing in three dimensions for the compressed 3D data. At each point in the 3D distance map the property layout system 104 records the distance to the nearest face in the 3D data. The property layout system 104 may calculate the distance by calculating the distance to all faces in the 3D data and recording the minimum. To speed up these calculations, the property layout system 104 may define a voxel grid and keep track of which faces intersect each voxel. The property layout system 104 may then calculate distances to faces for faces in voxels ordered from near to far until the minimum distance has been found. Additionally or alternatively, the property layout system 104 can render the faces on a skybox or in an equirectangular projection and use the Z-buffer to estimate the nearest face. In some embodiments, the property layout system 104 uses a combination of the voxel approach with the rendering approach.

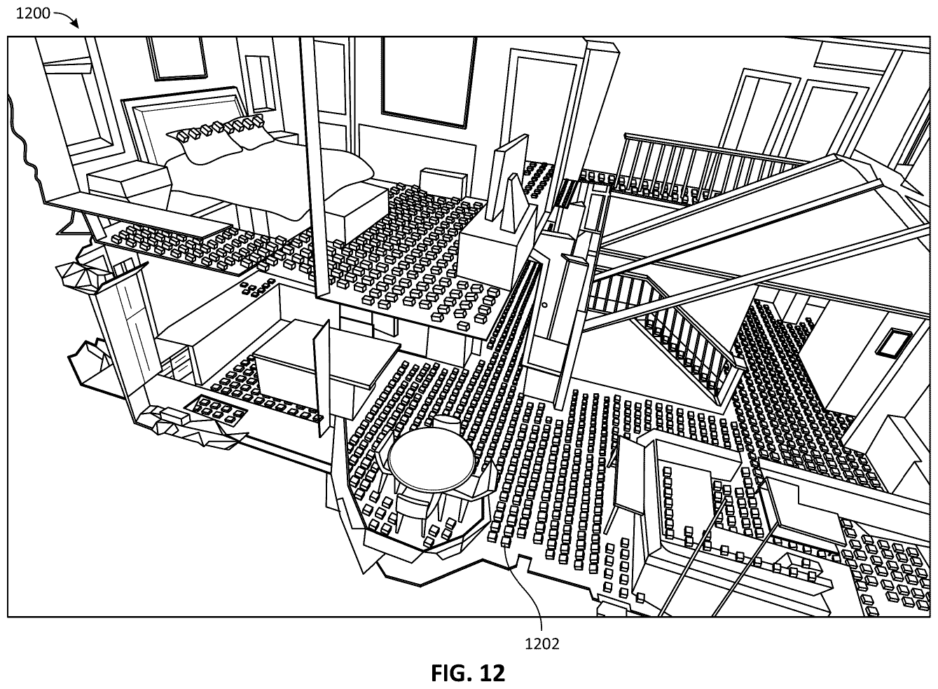

At each location in the 3D distance map for the compressed mesh where the distance to the nearest face is at least 0.6 m, the property layout system 104 determines that a human (of 1.8 m height) can fit at that location. The property layout system 104 examines these locations further by casting a ray down along the z-axis to find the face below. If there is no face below, the property layout system 104 determines that the location is not walkable. If there is a face, but the face is not leveled beyond some threshold (for example 30 degrees), the property layout system 104 determines that the location is not walkable. The property layout system 104 may cast multiple rays some distance apart instead of a single ray to mitigate the existence of holes in the 3D data or non-leveled faces between larger, leveled faces. The property layout system 104 places a peg on the surface below the corresponding location in the 3D distance map at each location that the property layout system 104 determines is walkable. FIG. 12 is a depiction 1200 of a building interior with pegs, such as a peg 1202, indicating walkable areas in the building according to some embodiments.

The property layout system 104 may classify tabletops, beds and other flat surfaces with sufficient ceiling height as walkable areas. The property layout system 104 may remove the classifications of such flat surfaces as walkable areas by rendering top-down views of the flat surfaces and identifying them as non-walkable flat surfaces by the steep cliffs surrounding them. Additionally or alternatively, the property layout system 104 may use this technique to avoid classifying such flat surfaces as walkable in the first instance.

The property layout system 104 may, given the set of pegs representing walkable areas, classify 3D faces as walkable by the proximity to pegs and by normal vectors of the 3D faces. Additionally or alternatively, the property layout system 104 may use a neural network to identify floor pixels in 2D images (with pinhole or equirectangular or spherical projections) taken from within the 3D data and project the floor pixels from the 2D image to the 3D data.

At step 504, the property layout system 104 (for example, the story identification module 210) clusters the walkable areas into one or more clusters for the one or more stories. The property layout system 104 may use K-means clustering to cluster the walkable areas into clusters of stories, one cluster per story.

At step 506, the property layout system 104 (for example, the story identification module 210) identifies, based on the one or more clusters, one or more floor surfaces. The property layout system 104 may assign the floor faces a story index. At step 508, the property layout system 104 (for example, the story identification module 210) identifies, for each floor surface of the one or more floor surfaces, one or more walls connected to each floor surface. The property layout system 104 may copy the story indices from floor faces to wall faces. In some embodiments, the property layout system 104 copies an index from a floor face to a wall face only if the wall face is connected to and above the floor face. Similarly, the property layout system 104 copies an index from a wall face to another wall face only if the wall face is connected to and above the other wall face. In various embodiments, the property layout system 104 may utilize a maximum distance between a wall face and the corresponding floor face to prevent unbound growth of story indices.

At step 510, the property layout system 104 (for example, the story identification module 210) generates, based on the one or more floor surfaces and the one or more walls connected to each floor surface of the one or more floor surfaces, the one or more story identifications. The property layout system 104 may run graph cut on the story indices recorded in the faces, one story at a time, to classify remaining faces. The property layout system 104 may also assign disjoint sub-meshes without story indices to stories based on their height and proximity to sub-meshes with story indices.

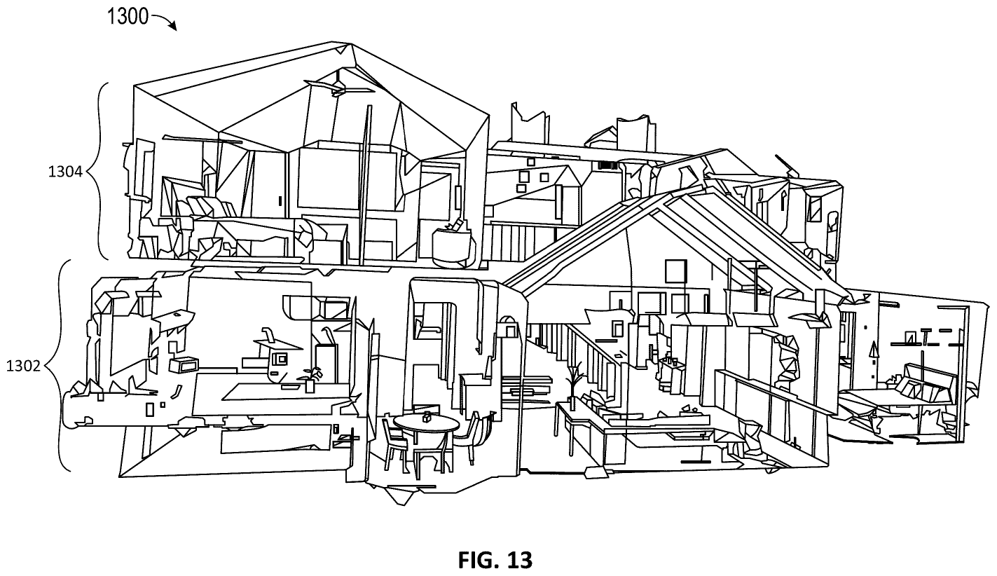

In various embodiments, the property layout system 104 may utilize in assigning stories user-provided data obtained during capture of 3D data or 2D data. Each sweep (a sweep may refer to a cycle in which 2D or 3D data is captured for an environment) that captures 3D data or 2D data may be utilized by the property layout system 104 to assign stories for all faces captured in the sweep. The property layout system 104 may weight this 3D data or 2D data based on the distance from the capture device to faces. Once the property layout system 104 has received data for all sweeps and has suitably weighted the data, the property layout system 104 may run graph cut to make final face to story assignments. FIG. 13 is a depiction of a building 1300 that has been separated into two stories, a first story 1302 and a second story 1304, in some embodiments.

Returning to FIG. 3, at step 308 the property layout system 104 (for example, the room identification module 212) generates, based on the 3D data, one or more room identifications of the one or more rooms. For example, the property layout system 104 may use the 3D data and optionally the one or more room classifications to generate the one or more room identifications. FIG. 6 is a flow diagram depicting a method 600 for generating room identifications according to some embodiments. The property layout system 104 (for example, various modules of the property layout system 104) may perform the method 600. The method 600 begins at a step 602 in which the property layout system 104 (for example, the room identification module 212) determines, based on the 3D data, one or more potential room centers. To do so, the property layout system 104 may create a 3D distance map with 0.20 m spacing in three dimensions for the compressed 3D data. At each point in the 3D distance map the property layout system 104 may record the distance to the nearest face in the 3D data. The property layout system 104 may calculate the distance by calculating the distance to all faces in the 3D data and recording the minimum. To speed up these calculations, the property layout system 104 may define a voxel grid and keep track of which faces intersect each voxel. The property layout system 104 may then calculate distances to faces for faces in voxels ordered from near to far until the minimum distance has been found. Additionally or alternatively, the property layout system 104 can render the faces on a skybox or in an equirectangular projection and use the Z-buffer to estimate the nearest face. In some embodiments, the property layout system 104 uses a combination of the voxel approach with the rendering approach. The property layout system 104 may record all local maxima in the 3D distance map. These maxima are potential room centers. Additionally or alternatively, the property layout system 104 may utilize locations where 3D data or 2D data was captured as potential room centers.

At step 604 the property layout system 104 (for example, the room identification module 212) determines one or more paths between one or more pairs of two potential room centers of the one or more potential room centers. The property layout system 104 may do so by, for each maximum, finding a path to the n nearest maxima. The property layout system 104 may also use the A* algorithm to find a path traversing the points in the 3D distance map. The cost of moving from one point to a neighboring point can be the average distance to the nearest surface for the two points. This prevents the path from being too close to surfaces. The cost of moving from one point to a neighboring point is infinite if a surface blocks the path between two points.

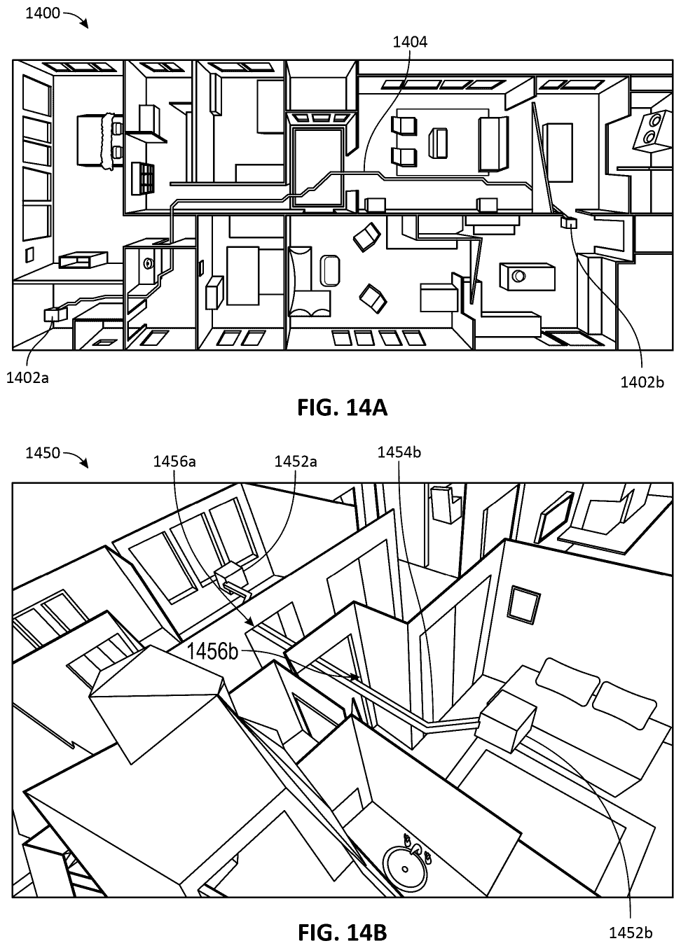

This prevents the path from going through surfaces. FIG. 14A depicts a top-down view 1400 of a building interior containing a path 1404 between a first potential room center 1402a and a second potential room center 1402b according to some embodiments. FIG. 14B depicts a perspective view 1450 of the building interior containing another path 1454 between a first potential room center 1402a and a second potential room center 1402b according to some embodiments. The path 1454 passes through a first doorway 1456a and a second doorway 1456b.

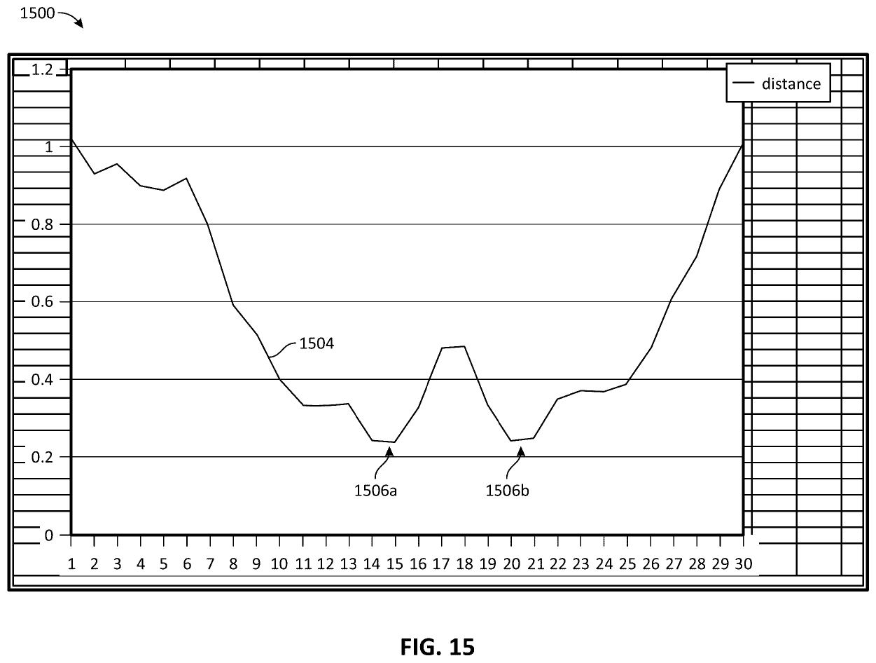

FIG. 15 depicts a graph 1500 that shows a line 1504 indicating the distance to the nearest surface from points on the path 1454 depicted in FIG. 14B in some embodiments. The distance to the nearest surface is expected to reach a local minimum every time a doorway is passed. In the graph 1500 there is a first local minimum 1506a and a second local minimum 1506b corresponding to the first doorway 1456a and the second doorway 1456b, respectively, that the path 1454 passes through.

Returning to FIG. 6, at step 606 the property layout system 104 (for example, the room identification module 212) determines, based on the one or more paths and the 3D data, one or more doorways. The property layout system 104 may identify doorway candidates by recording all the 3D locations of local minima in all the paths traversed between potential room centers. The property layout system 104 may promote a doorway candidate to a doorway if a door frame is found around the 3D location. The property layout system 104 may identify the doorframe by rendering up, down, left and right views with depth and using Hough transform to find depth edges that look like a door frame. From the depth images, the property layout system 104 may calculate an accurate location of the door frame and the width and height of the door frame. In general, doors have the same width and height as the doorway they are connected to. By looking for finite planes of the right size that intersect the doorway along the left or right edge, the property layout system 104 can identify open doors. Additionally or alternatively, the property layout system 104 can detect doorways by utilizing a neural network to analyze 2D images and project the results onto the 3D data, or by utilizing a neural network working directly on the 3D data.

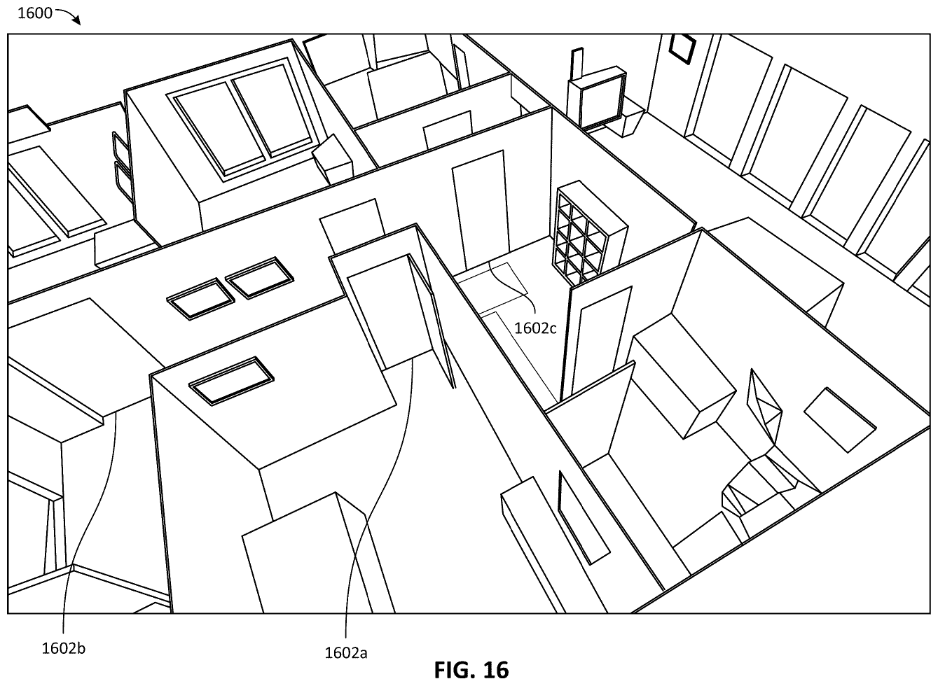

At step 608 the property layout system 104 (for example, the room identification module 212) blocks the one or more doorways to generate one or more blocked doorways. The property layout system 104 may block the doorways with finite planes. FIG. 16 is a depiction of a building interior 1600 with doorways blocked with finite planes according to some embodiments. The building interior 1600 depicts a first doorway blocked with a first finite plane 1602a, a second doorway blocked with a second finite plane 1602b, and a third doorway blocked with a third finite plane 1602c.

Returning to FIG. 6, at step 610 the property layout system 104 (for example, the room identification module 212) generates, based on the one or more potential room centers and the one or more blocked doorways, the one or more room identifications. Each room maximum casts votes on the faces that have line-of-sight to the maxima. Each room maximum is voting for itself. A room with a single room maximum will have its face voted for by a single sweep. When multiple maxima cast votes on the same faces, the property layout system 104 may utilize area overlap to determine if the maxima belong to the same room. The property layout system 104 may grow resulting room assignments from faces with known room assignments to faces without known room assignments. Additionally or alternatively, the property layout system 104 may utilize graph cut.

In addition to or as an alternative to the method 600, the property layout system 104 may utilize a random patch method to generate the one or more room identifications of the one or more rooms. The property layout system 104 may run edge breaker on the 3D data to break long edges. The property layout system 104 may select a first random face, and grow to a patch of connected faces above a minimum size. The minimum size should have a perimeter larger than the perimeter of any doorway between rooms to separate. The property layout system 104 may select a second random face and grow in a similar way. The property layout system 104 may use graph cut to find the smallest cut that separates the two patches. If the cut satisfy requirements of the type: mostly planar (singular value decomposition (SVD) may be used to determine best fit plane and the “planar-ness” of the cut), the plane is close to vertical, the cut has width and height typical for a doorway, and the cut is approximately rectangular, then the property layout system 104 may keep the cut, which separates two clusters of rooms. If not, the property layout system 104 may repeat by selecting two different patches. When the property layout system 104 finds a separation, the property layout system 104 may repeat for each sub-part of the 3D data.

In addition to or as an alternative to the above methods, the property layout system 104 may utilize a room classifier method to generate the one or more room identifications of the one or more rooms. The property layout system 104 may project the room classification confidences from a neural network onto the faces in the 3D data. The property layout system 104 may select two different room classifications. The property layout system 104 may run graph cut to separate the two classifications. The property layout system 104 may validate the cut as in the random patch method. The property layout system 104 may repeat for other sets of two room classifications. The property layout system 104 may repeat for each separated sub-part of the 3D data.

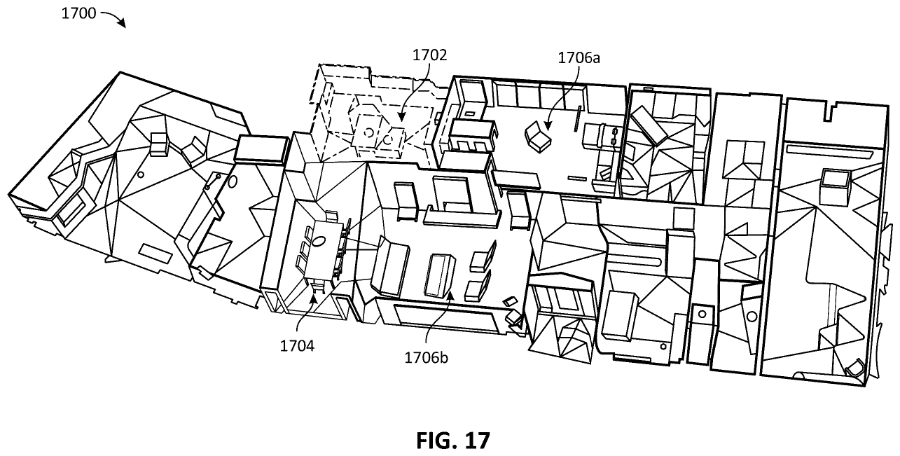

FIG. 17 is a depiction of a building 1700 with room classifications in some embodiments. The building 1700 includes a section 1702 that is primarily or predominantly a kitchen classification, a section 1704 that is primarily or predominantly a dining room classification, a first section 1706a that is primarily or predominantly a living room classification, and a second section 1706b that is also primarily or predominantly a living room classification. The property layout system 104 may separate the faces of the rooms, such as the kitchen faces from the living room faces, using graph cut.

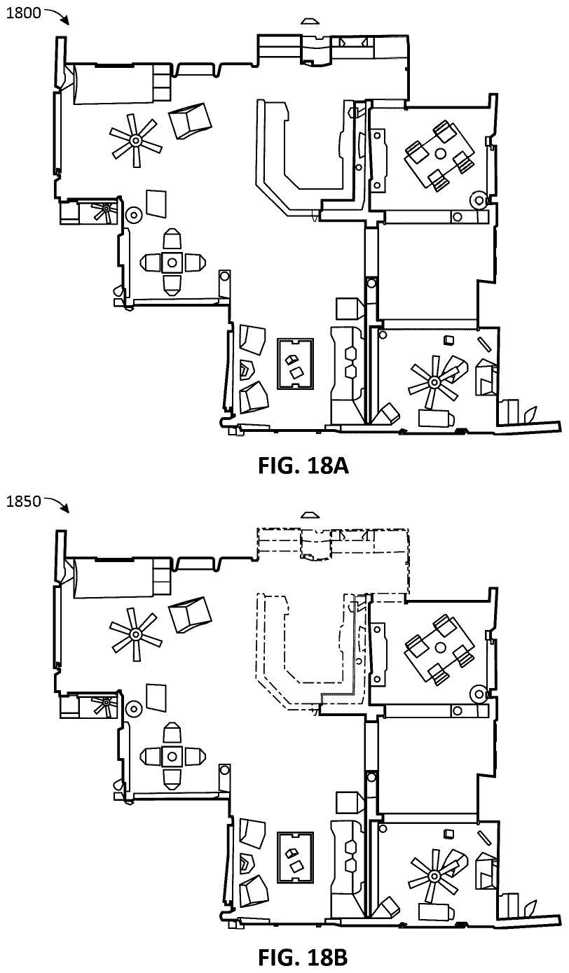

In addition to or as an alternative to the above methods, the property layout system 104 may utilize another room classifier method to generate the one or more room identifications of the one or more rooms. The property layout system 104 may render top-down, orthographic views and count the number of times each pixel is rendered scaled by size of the face. Assuming a resolution of 50 pixels/m, each pixel value may be the total face area intersecting a 2 centimeter (cm) by 2 cm column. The property layout system 104 may use these values (shifted a half pixel left or down) as the cost of making a cut between adjacent pixels. FIG. 18A is a depiction 1800 of pixel intensity proportional to mesh area intersecting a column passing through the pixel according to some embodiments.

The property layout system 104 may select one room classification, for example, the kitchen classification, and render a second top-down view of the room. The property layout system 104 may record for each pixel the confidence of being the selected classification (kitchen in this example) and also the confidence of not being selected classification (non-kitchen in this example). The property layout system 104 may accumulate confidences over the 3D surface intersecting the column corresponding to the pixel. The non-selected classification confidence can either be (1—the confidence of being the selected classification) or max (confidence of all classifications except the selected classification). The resulting two values are the cost of assigning each pixel to either selected classification or non-selected classification when running graph cut. FIG. 18B is a depiction 1850 of mesh face classification confidences in some embodiments.

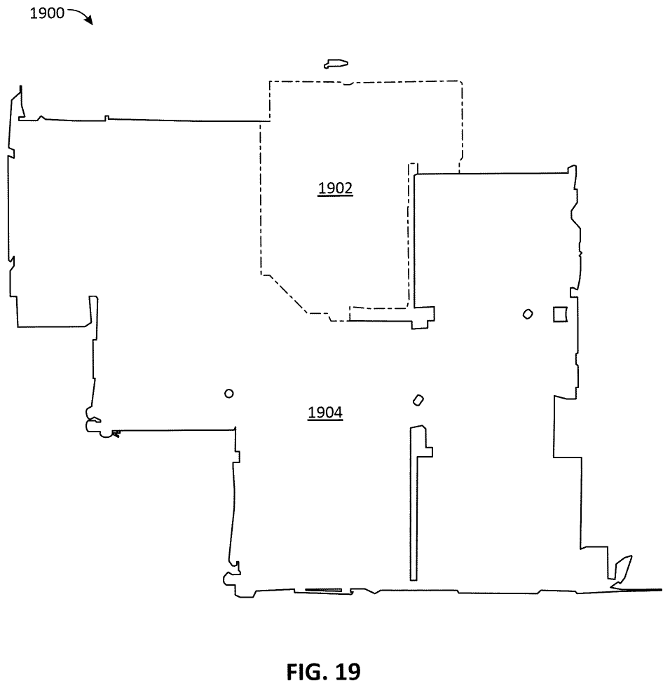

The property layout system 104 may run graph cut to separate out the room of the selected classification. The property layout system 104 may perform post-processing, such as: rejecting rooms determined to be too small (by story area), straightening the cut, and looking for doorways along the cut if finding doorways is desired. Once the property layout system 104 finalizes the cut in the top-down view, the property layout system 104 projects the separation from the 2D back to the 3D data. The property layout system 104 may repeat for other classifications and for sub-parts of the 3D data resulting from the described method. FIG. 19 depicts a result 1900 of a room separation process according to some embodiments. The result 1900 includes a section 1902 for a kitchen and a section 1904 for non-kitchen rooms.

Other approaches to generating story identifications or room identifications that the property layout system 104 may use include different types of rule-based systems or heuristics. For example, the property layout system 104 may find loops in a graph representing the environment as a way to detect and separate rooms. Other approaches can also include using neural networks to label each part of the environment as belonging to separate regions. For example, a top-down view of the 3D data of a story could be provided as input to an instance segmentation network which would label 2D regions of the image as separate room instances, and those 2D regions could then be projected back into 3D to separate the rooms in 3D. Direct 3D representations of the environment such as point clouds or graphs derived from a 3D mesh could also be provided as input to a neural network for this type of separation. Other approaches are possible.

In some embodiments, the property layout system 104 may utilize manual annotations, notes, or other data about the environment that may be available. For example, a user capturing the environment might have indicated story numbers associated with different parts of the capture process which could then be mapped into 3D locations and used to guide story separation.

Returning to FIG. 3, at step 310 the property layout system 104 (for example, the property layout generation module 214) generates, based on the one or more story identifications and the one or more room identifications, a property layout of the building that includes the one or more story identifications and the one or more room classifications. One example of a property layout is a 2D floor plan, but it will be understood that property layouts may include other simplified representations of a building interior, such as a simplified 3D mesh, a 3D floor plan, a constructive solid geometry representation, Building Information Modeling (BIM) data, or other 2D or 3D representations. One advantage of a property layout is that it makes important information about the environment more readily accessible to human viewers or automated tools while removing, hiding, or simplifying unnecessary clutter, detail, or noisy data.

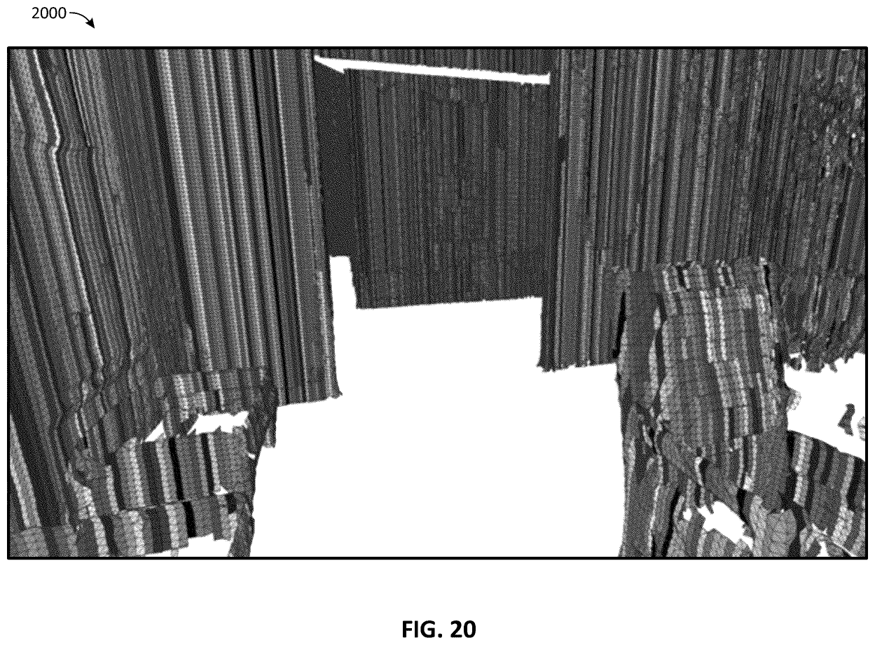

The property layout system 104 may generate a property layout by starting from 3D data (for example, one or more 3D meshes) that has been separated into one or more stories. For each story of the 3D data, the property layout system 104 keeps only the approximately vertical (wall-like) surfaces. The property layout system 104 connects the approximately vertical (wall-like) surfaces into vertical strips of connected mesh faces with approximately the same x, y coordinates (z being vertical) and x, y normal vectors. FIG. 20 is a depiction 2000 of approximately vertical wall surfaces of 3D data according to some embodiments.

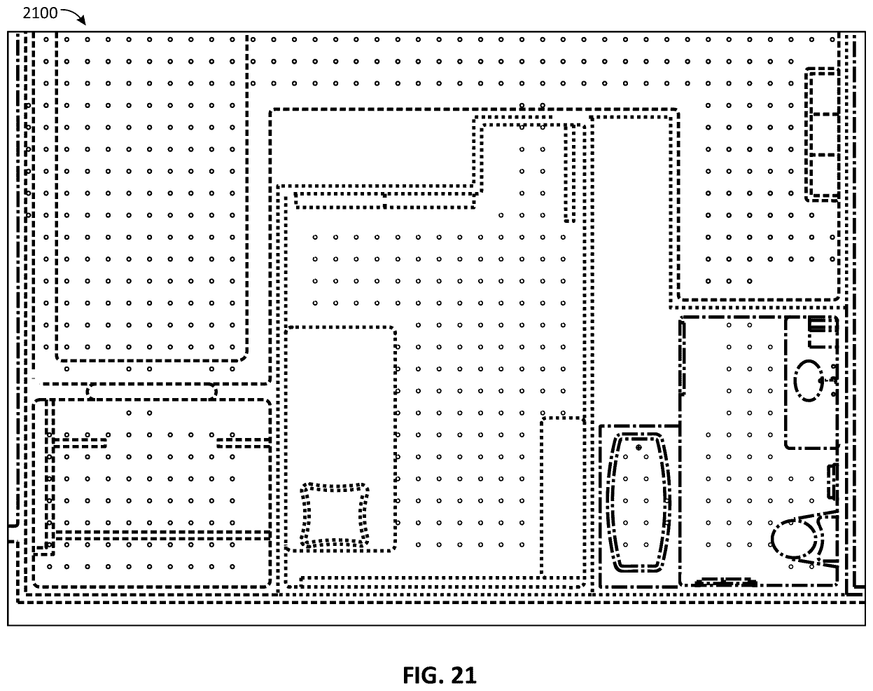

The property layout system 104 may then connect the vertical strips into a graph based on their connectivity in the 3D data to other vertical strips. The property layout system 104 may draw each edge in this graph as a line in a top down view, creating a floor plan of the environment with a similar level of detail as the 3D data. FIG. 21 depicts an example property layout 2100 based on connected vertical wall surfaces of a 3D mesh in some embodiments. The property layout 2100 has walls that are generally straight. However, the walls may have rounded corners where two walls meet, and other elements (for example, the bathtub and the sink) of the property layout 2100 may be simplified or non-uniform in appearance.

The property layout system 104 can then simplify this graph using a combination of a global nonlinear optimizer (such as Ceres Solver) and rule-based simplifications. The property layout system 104 may give the global nonlinear optimizer cost functions that edges of the graph should be colinear or perpendicular to each other along with other costs, constraints, and regularization such as not moving graph vertices too far from their initial positions. The global nonlinear optimizer then outputs new positions for each vertex in the graph to transform the graph into a graph that includes primarily straight lines and right angles, where such shapes are generally consistent with the original mesh geometry.

Additionally or alternatively, the property layout system 104 can apply rule-based simplification to the graph including path contraction for almost-colinear paths and merging or removing redundant paths through the graph. The property layout system 104 can identify and filter or remove parts of the graph that represent non-structural elements such as furniture based on properties of the paths such as being isolated sub-graphs (for example, a chair not touching any walls) or as being branching paths that are not the outermost of multiple branches with the same start and end point (for example, a chair touching a wall).

The property layout system 104 can apply these two methods of simplification-global optimization and rule-based simplification—in an alternating or iterative fashion to produce results that may be better than either method could produce alone. The global optimization may produce more paths that match the rule-based criteria for simplification, and the rule-based simplification may contract and simplify the graph structure so that the global optimizer has effectively a larger spatial context when optimizing costs that each apply to a local region of the graph.

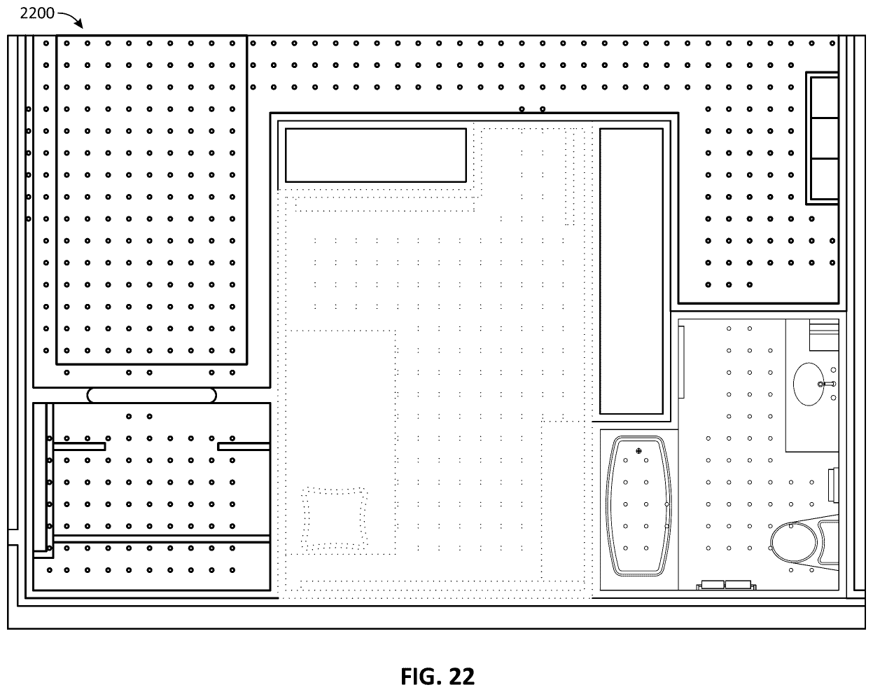

After this graph simplification, the top down view may have the appearance of a simplified, schematic floor plan with straight walls. FIG. 22 depicts another example property layout 2200 in some embodiments. The property layout 2200 has straight walls and the walls are at right angles to each other.

In addition to creating a graph that represents a simplified floor plan, the property layout system 104 may identify other information about the building interior or combine the other information with the graph representation. For example, the property layout system 104 can identify loops in the graph as room boundaries and utilize opposing wall surfaces to determine wall thickness. Details in the graph such as branches or sub-graphs that may have been simplified away earlier may be used by the property layout system 104 to identify details such as wall openings (for example, doorways, windows), structural features (for example, staircases, fireplaces), fixtures (for example, bathtubs, lights, or kitchen counters), and objects (for example, furniture). While the described graph can represent environments with any 3D structure, the property layout system 104 may create a 2D representation that does not allow overlap in 3D. For example, a story of a building might contain a closet underneath a staircase. The property layout system 104 may create a 2D property layout that does not draw the two features on top of each other. In this case the property layout system 104 may utilize heuristics or neural networks to decide which features should be shown at each 2D location in the case of such conflicts.

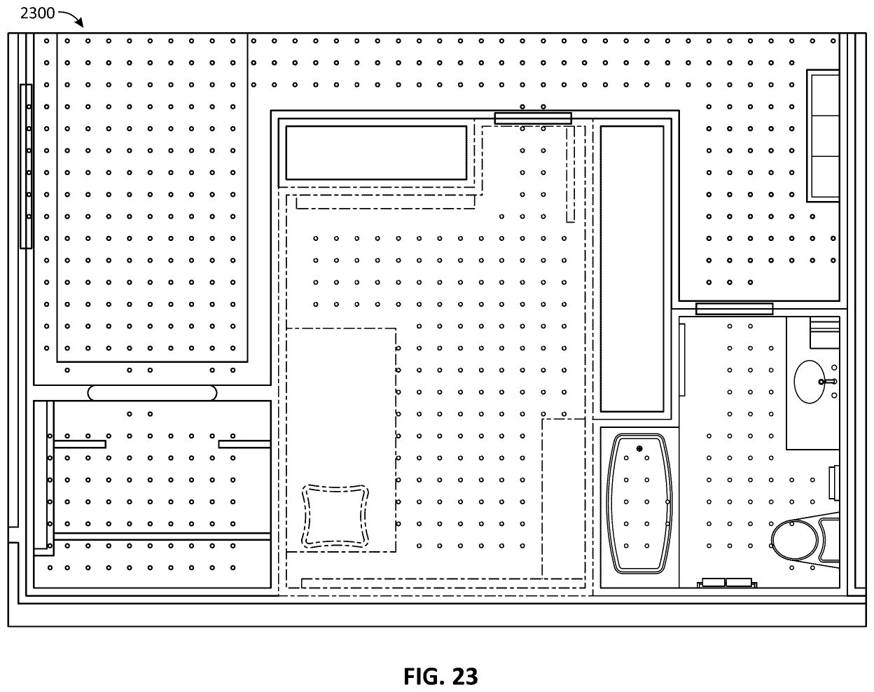

After the property layout system 104 has generated the property layout, the property layout system 104 can output the property layout in various formats such as 2D image(s) or documents (for example PDF file(s)), a 3D mesh or point cloud, vector data, or other structured data that contains the final, simplified graph structure. If objects and other features within the environment have been identified, an additional option for the final result is to replace those objects with similar 3D or 2D representations from a library. For example, a bathtub could be replaced by a standardized floor plan icon or graphic of a bathtub, or a chair could be replaced by a 3D model from a library of a similar or matching chair. FIG. 23 depicts another example property layout 2300 in some embodiments. The property layout 2300 depicts that the walls are of more or less uniform thicknesses.

The above description starts from 3D data (for example, one or more 3D meshes) that the property layout system 104 has utilized to identify stories, but there are many other starting points and options even within this graph simplification approach. For example, the property layout system 104 may use 3D data with no story identifications as input and identify the stories based on analysis of graph regions with certain altitudes and how the graph regions connect to each other. As another example, the property layout system 104 may also use identified rooms as an input that helps guide which simplifications to make and how to separate the final graph into labeled rooms. Another input from the story identification or the room identification that may be a useful input is the locations of walkable floor areas, which represents information about the environment not captured by the vertical mesh surfaces.

Various forms of region classification can also be direct input, such as semantic segmentation. For example, some surfaces of the 3D data could be classified as “wall” and others as “curtain”, and the graph simplification could allow larger tolerances for moving the “curtain” parts of the graph around, because the exact location of folds of a curtain is less important in a property layout, but tighter tolerances to avoid moving the “wall” parts of the graph around. Similarly, whether the property layout system 104 labels a surface as wall or as furniture could help distinguish between a wall and a tall wardrobe with similar geometry. Another possible input is room shape cues which have been extracted from 2D images or other data about an environment, such as floor-wall and ceiling-wall lines extracted from panoramic images. In addition to simplifying the property layout, the property layout system 104 may also infer missing data such as sections of walls that were behind furniture and thus not directly observed or walls or other structures that would complete regions with partial data. For example, the property layout system 104 may infer missing data for a room where some wall sections were not captured in the original data but enough of the shape of the room was captured that it can be completed using assumptions such as walls being planar, wall thicknesses being consistent in different parts of the environment, and so forth.

In addition to or as an alternative to a graph simplification approach, the property layout system 104 may use other methods for producing a property layout of an environment, such as a full mesh simplification method (using all 3D mesh surfaces and not just vertical surfaces), fitting planes or other shapes to a 3D representation such as a point cloud, a voxel or 2D grid approach based on identifying solid (for example, walls) vs. empty regions of the environment and simplifying those region boundaries, or neural networks which take data about the environment and output property layouts. Inputs to such neural networks could include direct or synthetic 2D images such as top-down views of the environment, voxel or other volume representations, point clouds, or graph representations such as 3D mesh connectivity, as well as other types of inputs. Outputs of such neural networks could include images such as from a diffusion network, vector representations, a series of tokens representing elements of the simplified structure such as from a large language model (LLM) style transformer network, or other representations.

The property layout system 104 may generate property layouts in addition to 2D (for example, a floor plan) or 3D (for example, a simplified 3D mesh) property layouts. For example, the property layout system 104 may generate a property layout that represents 3D data in a limited or constrained way, often described as 2.5D. For example, the output could be a floor plan representation in 2D coordinates but with elevation and height data for each wall, corner, and floor or ceiling surface. Another option would be to include information about ceiling and/or floor shapes, to better represent vaulted ceilings or multi-level rooms. These could include height maps, planar or other surface parameterization, full 3D representations such as meshes or point clouds, 2D shapes such as polygons oriented horizontally (for example ceiling and floor contours as seen from one or more side views), or other representations.

Returning to FIG. 3, at step 312 the property layout system 104 (for example, the measurements and dimensions module 216) determines, for at least one room of the one or more rooms, at least one of a room area, a room volume, a first room dimension, and a second room dimension. The property layout system 104 may also generate additional data about the environment such as measurements (linear, area, and/or volume) and room dimensions that are derived from the other data. For measurements and dimensions in particular, they can be chosen to be aligned to each particular room and to automatically choose the major or important dimensions of each room, such as a pair of orthogonal measurements that are also orthogonal to the room's walls and measure distances between the two longest sections of opposing wall in each direction.

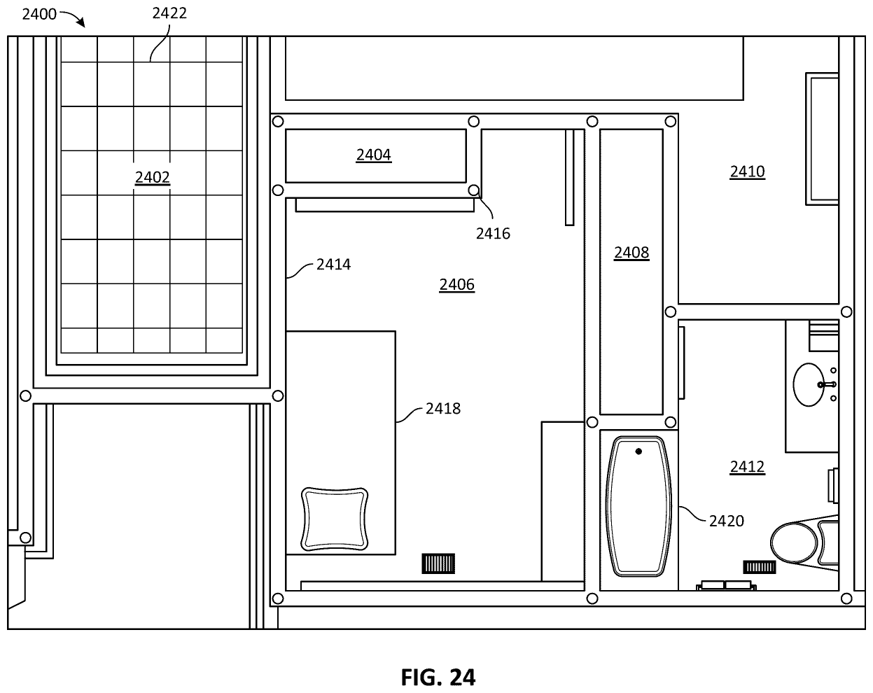

At step 314 the property layout system 104 (for example, the user interface module 218) provides the property layout for display. FIG. 24 depicts an example property layout 2400 as provided in a user interface according to some embodiments. The property layout 2400 is a top-down 2D view of a building interior and includes multiple room identifications, such as room identifications of a hallway 2402, a first unknown room 2404, a bedroom 2406, a second unknown room 2408, a living room 2410, and a bathroom 2412. The property layout 2400 may also display one or more measurements (linear, area, and/or volume) or room dimensions, such as the width and length of a room and the room area.

In various embodiments, the property layout system 104 may provide the property layout for display in an application or user interface that allows a user to view or edit the property layout. For example, the property layout system 104 has placed user-selectable elements at the vertices where walls of the property layout 2400 meet, such as vertex 2416. The user may select a vertex, such as the vertex 2416, and drag the vertex to a new location to correct the wall positions. The walls of the property layout 2400, such as a wall 2414, are also user-selectable and editable. The user may select a wall, such as the wall 2414, and drag the wall to a new location or change the thickness of the wall.

Another option for editing that the property layout system 104 may provide is to allow the user to select from predefined shapes or options such as common room shapes, types of vaulted ceilings, etc., which could then be automatically fitted or adapted to the available data. Editing operations such as these can be assisted or partially automated by features such as snapping to angles or positions that align to other walls or features in the environment, or by running some or all portions of the previous steps to complete the user's action. For example, if a user draws a new wall that splits a room into two rooms, the property layout system 104 can detect new loops in the graph and identify the two regions as separate rooms, and it could generate new measurements and dimensions for those rooms.

The property layout system 104 may also support editing that goes as far as completely rewriting or recreating the data, such as drawing new rooms or even buildings that were not part of the automatically generated data. As such, the property layout system 104 may allow the application or user interface to be used even when no 3D data is available. In addition to editing the property layout, story identification, and room identification data, the user may also edit classification data such as by changing the classification or label of a room, or by identifying and labeling a new object. These editing operations such as repositioning, adding, removing, modifying, and relabeling can also be applied to aspects of the representation such as detected objects, fixtures, or other features. For example, a user could change the size of a window, add a new measurement of the width of a room, remove a bathtub, or change a wall to instead be an invisible dividing line between open-plan rooms. Referring to FIG. 24, as non-limiting examples, the user could move a bed 2418 or change a style of a bathtub 2420 or of a sink 2422.

The viewing and/or editing can also happen in a 3D view such as from a perspective-camera viewpoint or from an orthographic viewpoint that is not aimed straight down at the model. Enabling viewing or editing in a 3D view can provide additional context to help the user understand the shapes in a floor plan even if the floor plan itself is 2D, or it can provide a way to view and understand the 2.5D or 3D data in the floor plan or other simplified representation of the environment. One way to provide access to this type of 3D view is to allow the user to smoothly tilt their view away from an orthographic top-down using controls such as a mouse or touch interface. The camera viewpoint, angle, and or virtual camera characteristics such as focal distance can be adjusted along with the mouse movement or other controls to create an intuitive transition from a floor plan view to an angled 3D view.

The view can be further adjusted to track the user controls so that the user can move between multiple viewpoints to see the environment from multiple angles. This type of control can also be made more convenient to use by providing an easy or automatic way to return to the previous view, such as by releasing the mouse button to snap back to an orthographic top down view. Another way to provide alternate viewpoints is to provide controls that cycle between different types of views and/or display views from multiple positions or angles simultaneously. For example, the system could provide a control to switch to an orthographic side view of the environment in which the user could see the shapes of ceilings or floors. Just as the viewer can show slices or portions of the model from above (for example, showing a single floor of a multi-floor building) a side view could filter or dim some portions of the environment so that a user could clearly see the shapes of certain parts of the environment, such as one or more specific rooms. An example of the multiple viewpoint case would be to display one type of view (for example, a top-down view) on part of the screen and then another type of view (for example, a side view or inside view) on another part of the screen such as with a split-screen view or an overlay view with one view set inside a portion of the other view.

This type of interactive viewer or editor which also shows other information about the environment beyond its floor plan or simplified representation (like a 3D textured mesh in the case of certain applications) is not necessarily required, and other options include applications that display only the floor plan itself. Such an application could still provide all of the viewing and editing options described above, including displaying any 3D context that is available as part of the simplified representation itself. Non-interactive display options are also possible, such as viewing a 2D image of the floor plan in an image viewer. This could be accomplished with a viewer application that is part of the system but could also be accomplished by creating outputs such as images or other files that could then be viewed in third-party applications, printed and viewed as physical objects.

Returning to FIG. 3, at step 316 the property layout system 104 (for example, the communication module 202) receives one or more modifications to the property layout. At step 318 the property layout system 104 (for example, the property layout generation module 214) generates, based on the one or more modifications, a modified property layout. At step 320 the property layout system 104 (for example, the user interface module 218) provides the modified property layout for display.

FIG. 25 depicts a block diagram of an example digital device 2500 according to some embodiments. The digital device 2500 is shown in the form of a general-purpose computing device. The digital device 2500 includes at least one processor 2502, RAM 2504, communication interface 2506, input/output device 2508, storage 2510, and a system bus 2512 that couples various system components including storage 2510 to the at least one processor 2502. A system, such as a computing system, may be or include one or more of the digital device 2500.

System bus 2512 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

The digital device 2500 typically includes a variety of computer system readable media, such as computer system readable storage media. Such media may be any available media that is accessible by any of the systems described herein and it includes both volatile and nonvolatile media, removable and non-removable media.

In some embodiments, the at least one processor 2502 is configured to execute executable instructions (for example, programs). In some embodiments, the at least one processor 2502 comprises circuitry or any processor capable of processing the executable instructions.

In some embodiments, RAM 2504 stores programs and/or data. In various embodiments, working data is stored within RAM 2504. The data within RAM 2504 may be cleared or ultimately transferred to storage 2510, such as prior to reset and/or powering down the digital device 2500.

In some embodiments, the digital device 2500 is coupled to a network, such as the communication network 108, via communication interface 2506. The digital device 2500 can communicate with one or more networks such as a local area network (LAN), a general wide area network (WAN), and/or a public network (for example, the Internet).

In some embodiments, input/output device 2508 is any device that inputs data (for example, mouse, keyboard, stylus, sensors, etc.) or outputs data (for example, speaker, display, virtual reality headset).

In some embodiments, storage 2510 can include computer system readable media in the form of non-volatile memory, such as read only memory (ROM), programmable read only memory (PROM), solid-state drives (SSD), flash memory, and/or cache memory. Storage 2510 may further include other removable/non-removable, volatile/non-volatile computer system storage media. By way of example only, storage 2510 can be provided for reading from and writing to a non-removable, non-volatile magnetic media. The storage 2510 may include a non-transitory computer-readable medium, or multiple non-transitory computer-readable media, which stores programs or applications for performing functions such as those described herein with reference to, for example, FIG. 2. Although not shown, a magnetic disk drive for reading from and writing to a removable, non-volatile magnetic disk (for example, a “floppy disk”), and an optical disk drive for reading from or writing to a removable, non-volatile optical disk such as a CDROM, DVD-ROM or other optical media can be provided. In such instances, each can be connected to system bus 2512 by one or more data media interfaces. As will be further depicted and described below, storage 2510 may include at least one program product having a set (for example, at least one) of program modules that are configured to carry out the functions of embodiments of the invention. In some embodiments, RAM 2504 is found within storage 2510.

Programs/utilities, having a set (at least one) of program modules, such as the property layout system, may be stored in storage 2510 by way of example, and not limitation, as well as an operating system, one or more application programs, other program modules, and program data. Each of the operating system, one or more application programs, other program modules, and program data or some combination thereof, may include an implementation of a networking environment. Program modules generally carry out the functions and/or methodologies of embodiments of the invention as described herein.

It should be understood that although not shown, other hardware and/or software components could be used in conjunction with the digital device 2500. Examples include, but are not limited to microcode, device drivers, redundant processing units, and external disk drive arrays, RAID systems, tape drives, and data archival storage systems, etc.

Exemplary embodiments are described herein in detail with reference to the accompanying drawings. However, the present disclosure can be implemented in various manners, and thus should not be construed to be limited to the embodiments disclosed herein. On the contrary, those embodiments are provided for the thorough and complete understanding of the present disclosure, and completely conveying the scope of the present disclosure.

It will be appreciated that aspects of one or more embodiments may be embodied as a system, method, or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), a solid state drive (SSD), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program or data for use by or in connection with an instruction execution system, apparatus, or device.

A transitory computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object-oriented programming language such as Java, Smalltalk, C++, Python, or the like and conventional procedural programming languages, such as the “C” programming language or similar programming languages. The computer program code may execute entirely on any of the systems described herein or on any combination of the systems described herein.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

While specific examples are described above for illustrative purposes, various equivalent modifications are possible. For example, while processes or blocks are presented in a given order, alternative implementations may perform routines having steps, or employ systems having blocks, in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed or implemented concurrently or in parallel or may be performed at different times. Further any specific numbers noted herein are only examples: alternative implementations may employ differing values or ranges.

Throughout this specification, plural instances may implement components, operations, or structures described as a single instance. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. Furthermore, any specific numbers noted herein are only examples: alternative implementations may employ differing values or ranges.

Components may be described or illustrated as contained within or connected with other components. Such descriptions or illustrations are examples only, and other configurations may achieve the same or similar functionality. Components may be described or illustrated as “coupled,” “couplable,” “operably coupled,” “communicably coupled” and the like to other components. Such description or illustration should be understood as indicating that such components may cooperate or interact with each other, and may be in direct or indirect physical, electrical, or communicative contact with each other.

Components may be described or illustrated as “configured to,” “adapted to,” “operative to,” “configurable to,” “adaptable to,” “operable to” and the like. Such description or illustration should be understood to encompass components both in an active state and in an inactive or standby state unless required otherwise by context.

The use of “or” in this disclosure is not intended to be understood as an exclusive “or.” Rather, “or” is to be understood as including “and/or.” For example, the phrase “providing products or services” is intended to be understood as having several meanings: “providing products,” “providing services,” and “providing products and services.”

It may be apparent that various modifications may be made, and other embodiments may be used without departing from the broader scope of the discussion herein. For example, although the image retrieval and processing module 204 is described as receiving images, such as 360 degree images, the image retrieval and processing module 204 may also receive video, 3D data, or other data in other formats. Therefore, these and other variations upon the example embodiments are intended to be covered by the disclosure herein.

1. A non-transitory computer-readable medium comprising executable instructions, the executable instructions being executable by one or more processors to perform a method, the method comprising:
receiving 3D data of an interior of a building, the building having one or more stories and one or more rooms on the one or more stories;
classifying the 3D data by:
receiving multiple 360 degree panoramic images of the interior, the multiple 360 degree panoramic images associated with the 3D data;
applying a trained model to classify the multiple 360 degree panoramic images; and
determining, based on applying the trained model to classify the multiple 360 degree panoramic images, one or more room classifications for the 3D data;
generating, based on the 3D data, one or more story identifications of the one or more stories and one or more room identifications of the one or more rooms;
generating, based on the one or more story identifications and the one or more room identifications, a property layout of the building, the property layout including the one or more story identifications and the one or more room classifications; and
providing the property layout for display.

2. The non-transitory computer-readable medium of claim 1 wherein applying the trained model to classify the multiple 360 degree panoramic images includes:
for each 360 degree panoramic image of the multiple 360 degree panoramic images:
dividing each 360 degree panoramic image into multiple sections; and
applying the trained model to classify each section of the multiple sections, thereby obtaining multiple section classifications,
wherein determining, based on applying the trained model to classify the multiple 360 degree panoramic images, the one or more room classifications for the 3D data includes determining, based on the multiple section classifications for each 360 degree panoramic image, the one or more room classifications for the 3D data.

3. The non-transitory computer-readable medium of claim 1 wherein generating, based on the 3D data, the one or more story identifications includes:
identifying walkable areas in the 3D data;
clustering the walkable areas into one or more clusters for the one or more stories;
identifying, based on the one or more clusters, one or more floor surfaces;
identifying, for each floor surface of the one or more floor surfaces, one or more walls connected to each floor surface; and
generating, based on the one or more floor surfaces and the one or more walls connected to each floor surface of the one or more floor surfaces, the one or more story identifications.

4. The non-transitory computer-readable medium of claim 3 wherein identifying the walkable areas in the 3D data includes:
generating, based on the 3D data, a 3D distance map;
determining, for each point of multiple points in the 3D distance map, a distance from each point to a nearest surface of the 3D data; and
identifying, based on the distance from each point to the nearest surface of the 3D data, the walkable areas in the 3D data.

5. The non-transitory computer-readable medium of claim 4 wherein identifying the walkable areas in the 3D data further includes:
generating an ellipsoid representing a human;
scaling down by a factor in a z-direction the ellipsoid to a sphere; and
scaling down by the factor in the z-direction the 3D data,
wherein identifying, based on the distance from each point to the nearest surface of the 3D data, the walkable areas in the 3D data includes identifying, based on the distance from each point to the nearest surface of the 3D data and a diameter of the sphere, the walkable areas in the 3D data.

6. The non-transitory computer-readable medium of claim 1 wherein generating, based on the 3D data, the one or more room identifications includes:
determining, based on the 3D data, one or more potential room centers;
determining one or more paths between one or more pairs of two potential room centers of the one or more potential room centers;
determining, based on the one or more paths and the 3D data, one or more doorways;
blocking the one or more doorways to generate one or more blocked doorways; and
generating, based on the one or more potential room centers and the one or more blocked doorways, the one or more room identifications.

7. The non-transitory computer-readable medium of claim 1 wherein generating, based on the one or more story identifications and the one or more room identifications, the property layout of the building includes:
generating, based on the one or more story identifications, one or more graphs;
for each graph of the one or more graphs, simplifying each graph to generate a simplified graph, thereby generating one or more simplified graphs; and
generating, based on the one or more simplified graphs and the one or more room identifications, the property layout of the building.

8. The non-transitory computer-readable medium of claim 7 wherein simplifying each graph to generate the simplified graph includes simplifying each graph using at least one of a global nonlinear optimizer and one or more rule-based simplifications.

9. The non-transitory computer-readable medium of claim 1, the method further comprising determining, for at least one room of the one or more rooms, at least one of a room area, a room volume, a first room dimension, and a second room dimension, wherein providing the property layout for display includes providing, for the at least one room of the one or more rooms, at least one of the room area, the room volume, the first room dimension, and the second room dimension for display.

10. The non-transitory computer-readable medium of claim 1, the method further comprising:
receiving one or more modifications to the property layout;
generating, based on the one or more modifications, a modified property layout; and
providing the modified property layout for display.

11. A method comprising:
receiving 3D data of an interior of a building, the building having one or more stories and one or more rooms on the one or more stories;
classifying the 3D data by:
receiving multiple 360 degree panoramic images of the interior, the multiple 360 degree panoramic images associated with the 3D data;
applying a trained model to classify the multiple 360 degree panoramic images; and
determining, based on applying the trained model to classify the multiple 360 degree panoramic images, one or more room classifications for the 3D data;
generating, based on the 3D data, one or more story identifications of the one or more stories and one or more room identifications of the one or more rooms;
generating, based on the one or more story identifications and the one or more room identifications, a property layout of the building, the property layout including the one or more story identifications and the one or more room classifications; and
providing the property layout for display.

12. The method of claim 11 wherein applying the trained model to classify the multiple 360 degree panoramic images includes:
for each 360 degree panoramic image of the multiple 360 degree panoramic images:
dividing each 360 degree panoramic image into multiple sections; and
applying the trained model to classify each section of the multiple sections, thereby obtaining multiple section classifications,
wherein determining, based on applying the trained model to classify the multiple 360 degree panoramic images, the one or more room classifications for the 3D data includes determining, based on the multiple section classifications for each 360 degree panoramic image, the one or more room classifications for the 3D data.

13. The method of claim 11 wherein generating, based on the 3D data, the one or more story identifications includes:
identifying walkable areas in the 3D data;
clustering the walkable areas into one or more clusters for the one or more stories;
identifying, based on the one or more clusters, one or more floor surfaces;
identifying, for each floor surface of the one or more floor surfaces, one or more walls connected to each floor surface; and
generating, based on the one or more floor surfaces and the one or more walls connected to each floor surface of the one or more floor surfaces, the one or more story identifications.

14. The method of claim 13 wherein identifying the walkable areas in the 3D data includes:
generating, based on the 3D data, a 3D distance map;
determining, for each point of multiple points in the 3D distance map, a distance from each point to a nearest surface of the 3D data; and
identifying, based on the distance from each point to the nearest surface of the 3D data, the walkable areas in the 3D data.

15. The method of claim 14 wherein identifying the walkable areas in the 3D data further includes:
generating an ellipsoid representing a human;
scaling down by a factor in a z-direction the ellipsoid to a sphere; and
scaling down by the factor in the z-direction the 3D data, wherein identifying, based on the distance from each point to the nearest surface of the 3D data, the walkable areas in the 3D data includes identifying, based on the distance from each point to the nearest surface of the 3D data and a diameter of the sphere, the walkable areas in the 3D data.

16. The method of claim 11 wherein generating, based on the 3D data, the one or more room identifications includes:
determining, based on the 3D data, one or more potential room centers;
determining one or more paths between one or more pairs of two potential room centers of the one or more potential room centers;
determining, based on the one or more paths and the 3D data, one or more doorways;
blocking the one or more doorways to generate one or more blocked doorways; and
generating, based on the one or more potential room centers and the one or more blocked doorways, the one or more room identifications.

17. The method of claim 11 wherein generating, based on the one or more story identifications and the one or more room identifications, the property layout of the building includes:
generating, based on the one or more story identifications, one or more graphs;
for each graph of the one or more graphs, simplifying each graph to generate a simplified graph, thereby generating one or more simplified graphs; and
generating, based on the one or more simplified graphs and the one or more room identifications, the property layout of the building.

18. The method of claim 17 wherein simplifying each graph to generate the simplified graph includes simplifying each graph using at least one of a global nonlinear optimizer and one or more rule-based simplifications.

19. The method of claim 11, further comprising determining, for at least one room of the one or more rooms, at least one of a room area, a room volume, a first room dimension, and a second room dimension, wherein providing the property layout for display includes providing, for the at least one room of the one or more rooms, at least one of the room area, the room volume, the first room dimension, and the second room dimension for display.

20. The method of claim 11, further comprising:
receiving one or more modifications to the property layout;
generating, based on the one or more modifications, a modified property layout; and
providing the modified property layout for display.

21. A system comprising at least one processor and at least one memory including executable instructions that when executed by the at least one processor cause the system to:
receive 3D data of an interior of a building, the building having one or more stories and one or more rooms on the one or more stories;
classify the 3D data by:
receiving multiple 360 degree panoramic images of the interior, the multiple 360 degree panoramic images associated with the 3D data;
applying a trained model to classify the multiple 360 degree panoramic images; and
determining, based on applying the trained model to classify the multiple 360 degree panoramic images, one or more room classifications for the 3D data;
generate, based on the 3D data, one or more story identifications of the one or more stories and one or more room identifications of the one or more rooms;
generate, based on the one or more story identifications and the one or more room identifications, a property layout of the building, the property layout including the one or more story identifications and the one or more room classifications; and
provide the property layout for display.
